(19) United States
(12) Patent Application Publication
(10) Pub. No.: US 2022/0230209 A1
(43) Pub. Date: Jul. 21, 2022

(54) MARKETING INFERENCE ENGINE AND METHOD THEREFOR

(71) Applicant: AFFINIO INC., Halifax (CA)

(72) Inventor: Philip Joseph RENAUD, Toronto (CA)

(21) Appl. No.: 17/609,397

(22) PCT Filed: May 22, 2020
(86) PCT No.: PCT/CA2020/050699

§ 371 Date: Nov. 7, 2021

Related U.S. Application Data
(60) Provisional application No. 62/851,289, filed on May 22, 2019.
(60) Provisional application No. 62/937,333, filed on Nov. 19, 2019.

(30) Foreign Application Priority Data
Dec. 24, 2019 (IB) PCT/IB2019/061346

(51) Int. Cl. G06Q 30/02

(52) U.S. Cl. CPC G06Q 30/0282; G06Q 30/0201

(57) ABSTRACT

A marketing inference engine determines prospective clients, drawn from a population of users, for a commodity. A set of relevant consumer traits is conjectured or determined from data relevant to prior clients of the commodity. Massive data characterizing the population is analysed to determine a superset of user communities of the population of users, each community corresponding to a respective trait of a predefined superset of traits. A set of primary communities, corresponding to the set of relevant consumer traits, is selected from the superset of communities. A set of secondary communities, each determined to have a significant kinship to the set of primary communities, is selected from the superset of communities. A set of primary prospective clients is determined from the primary communities. An expanded set of prospective clients is determined from both the primary communities and the secondary communities.

### CROSS-REFERENCE TO RELATED APPLICATIONS

The present application claims the benefit of:

U.S. provisional application 62/851,289 filed on May 22, 2019, entitled “METHOD AND SYSTEM FOR MACHINE-AIDED MARKETING BASED ON RELATING COMMODITIES TO TRAITS OF RESPECTIVE CONSUMERS” (Attorney docket number AFI-011-US-prov);

International PCT application PCT/IB2019/061346 filed Dec. 24, 2019 entitled “MARKETING ENGINE BASED ON TRAITS AND CHARACTERISTICS OF PROSPECTIVE CONSUMERS” (Attorney docket number AFI-010-PCT); and

U.S. provisional application 62/937,333 filed Nov. 19, 2019 entitled “METHOD AND APPARATUS FOR DIRECTING ACQUISITION OF INFORMATION IN A SOCIAL NETWORK” (Attorney docket number AFI-013-US-prov);

the entire contents of all applications being incorporated herein by reference.

### FIELD OF THE INVENTION

The present invention relates to machine-aided marketing based on relating commodities to traits of respective consumers.

### BACKGROUND

It is well recognized that characterizing prospective consumers of a commodity is essential for enabling a focused marketing effort, hence successful promotion of the commodity. Conventionally, distinguishing potential consumers has been based on static and/or quasi static properties of members of a tracked population.

There is a need, however, to further explore methods for more inclusively associating a commodity with a respective segment of the tracked population.

### SUMMARY

In accordance with an aspect, the invention provides a method comprising executing instructions causing a processor to perform processes leading to determining prospective clients for a specific commodity (product or service).

A superset of communities of a universe of users, each community corresponding to a respective trait of a superset of predefined traits is either determined in a pre-processing stage or acquired from external sources. For a specific commodity selected from a list of commodities of interest, data relevant to prior clients of the specific commodity is acquired and a set of relevant traits of the prior clients is determined based on the prior clients' data. A set of primary communities, corresponding to the set of relevant traits, is then selected from the superset of communities. A set of prospective clients is determined as a function of the primary communities. Information relevant to the specific commodity is then communicated to the set of prospective clients.

The relevance of a specific trait of the superset of predefined traits is based on a ratio of a number of clients of the set of prior clients determined to have the specific trait to the size of the community of the set of communities corresponding to the specific trait. A preferred procedure for determining a set of relevant traits comprises processes of acquiring the size of each community of the superset of communities, initializing a set of relevant traits as an empty set, and determining for each trait of the superset of predefined traits a respective trait score as a number of clients of the set of prior clients determined to have the trait. The following iterative processes are then performed:
(1) prorating each trait score to a nominal community size to produce prorated initial scores;
(2) transferring a particular trait of highest prorated score to the set of relevant traits; and
(3) adjusting the score of each of the remaining traits of the superset of predefined traits to exclude users already included in the particular trait.

The iterative processes continue until the highest score of the remaining traits is below a predefined level.

So far, the set of prospective clients is selected from the primary communities of users. In order to expand the set of prospective clients, other communities of high kinship to the primary communities may be considered. Thus, the method further determines a set of secondary communities from the superset of communities based on a measure of kinship of each community, excluding the primary communities, to the set of primary community. The set of prospective clients is then expanded to be based on both the primary communities and the secondary communities.

According to an embodiment, the measure of kinship is a weighted sum of pairwise kinship values of each candidate secondary community to the set of primary community determined as:

$${{Λ}_{k}}^{*} = {Σ}_{0 \leq j < Γ} ( {η}_{j} \times {Λ}_{j . k} )$$

where:

ηⱼ denotes a relevance level of a primary community of index j, and Λ_{j,k} denotes pairwise kinship of a candidate community of index k to a primary community of index j, 0≤j<Γ, Γ≤k<H, H being a count of the total number of communities of the set of communities, Γ being a count of the primary communities, indexed as 0 to (Γ−1).

A first measure of pairwise kinship, hereinafter referenced as a “type-1 kinship”, of a first community to a second community is based on a number of users belonging to the first community, a number of users belonging to the second community, and a number of common users belonging to both communities. The type-1 kinship may be defined as:
(1) a ratio of the number of common users to a number of users belonging to the union of the two communities;
(2) a ratio of the number of common users to an arithmetic mean value of the number of users belonging to the first community and the number of users belonging to the second community; or
(3) a ratio of the number of common users to a geometric mean value of the number of users belonging to the first community and the number of users belonging to the second community.

The method further comprising processes of segmenting the universe of users into a set of clusters according to individual characteristics of each user of the universe of users and determining a saturation-score vector of each community of the superset of communities as a size of intersection of each community with each cluster of the set of clusters. The saturation-score vector is normalized to a sum of unity to produce a saturation-level vector.

A second measure of pairwise kinship, hereinafter referenced as a “type-2 kinship”, of a first community to a second community, is based on proximity of saturation-level vectors of the two communities. A third measure of pairwise kinship, hereinafter referenced as a “type-3 kinship”, of a first community to a second community, is based on cross-correlation of saturation-level vectors of the two communities.

The type-1 pairwise kinship of a first community of index u to a second community of index v is determined as:

$${g}_{1 , u , v} = {N}_{c} / ( {N}_{u} + {N}_{v} - {N}_{c} ) ;$$

$$or$$

$${g}_{1 , u , v} = 2 \times {N}_{c} / ( {N}_{u} + {N}_{v} ) ;$$

$$or$$

$${g}_{1 , u , v} = {N}_{c} / {( {N}_{u} + {N}_{v} )}^{1 / 2} ;$$

wherein Nu is a number of users belonging to the first community, Nv is the number of users belonging to the second community, and Nc is the number of users belonging to the intersection of the first community and the second community.

The type-2 pairwise kinship of the first community to the second community is determined as: g_{2,u,v}=1.0−Σ_{K}|αⱼ−βⱼ|, 0≤j<K,

where:
K is a number of clusters, K>1,
αⱼ is a normalized saturation level of the first community within cluster j determined as a ratio of the number of users belonging to both the first community and cluster j to the number of users belonging to the first community; and
βⱼ is a normalized saturation level of the second community within cluster j determined as a ratio of the number of users belonging to both the second community and cluster j to the number of users belonging to the second community.

The type-3 pairwise kinship of the first community to the second community is determined as:

$${g}_{3 , u , v} = ( {Σ}_{0 < j < K} ( {n}_{j} \times {m}_{j} ) - K \times \text{<} n \text{>} \times \text{<} \text{m} \text{>} ) / ( K \times {σ}_{n} \times {σ}_{m} ) ,$$

wherein:

nⱼ, is a saturation score of the first community within cluster j,

mⱼ is saturation score of the second community within cluster j, 0≤j<K,

<n> is the mean value of saturation scores of the first community,

<m> is the mean value of saturation scores of the second community,

σₙ is the standard deviation of the saturation score of the first community, and

σₘ is the standard deviation of the saturation score of the second community.

The kinship measure of any secondary community to any primary community may be determined as a function of at least two of:

a ratio the intersection of the two communities to the union of the two communities;

a proximity coefficient of saturation vectors of the two communities; and

a cross-correlation coefficient of saturation vectors of the two communities.

Preferably, the processes of determining a set of communities of the universe of users and segmenting the universe of users into a set of clusters are performed a priori in pre-processing modules for frequent use in determining prospective clients for different commodities.

In accordance with another aspect, the invention provides a method of advertising implemented at an apparatus comprising a processor and memory devices. The method comprises accessing a database providing traits, of a predefined superset of traits, of each user of a population of users and determining a superset of communities, each community comprising users determined to have a respective trait of the predefined superset of traits.

Upon receiving identifiers of a set of primary communities of interest, where the primary communities belong to the superset of communities, a set of secondary communities, belonging to the superset of communities, having a significant kinship to the set of primary communities is determined.

The set of secondary communities is initialized as an empty set and each community of the superset of communities, excluding the set of primary communities, is a candidate for joining the set of secondary communities.

For each candidate community, a measure of kinship to the set of primary communities is determined. A candidate community having a measure of kinship exceeding a predefined level is added to the set of secondary communities. A set of prospective clients is then determined based on the set of primary communities and the set of secondary communities. Appropriate marketing information is communicated to the community of prospective clients.

The set of prospective clients is determined as a union of the primary communities of the set of primary communities and the secondary communities of the set of secondary communities. Furthermore, users belonging to intersections of communities, primary or secondary, may be considered principal prospective clients.

The measure of kinship of a candidate community to the set of primary communities is determined as a sum of pairwise kinship levels of the candidate community to each primary community of the set of primary communities.

The method further comprises segmenting the plurality of users into a number K of clusters, K>1, according to individual characteristics of users of the plurality of users. The characteristics of users may be determined from the aforementioned database, or from another source. A K-dimensional saturation vector of any community within the K clusters is determined according to intersection of the community with each cluster of the K clusters.

A pairwise kinship levels of a candidate community to a specific primary community of the set of primary communities may be determined according to:
(a) a number of users belonging to the candidate community, a number of users belonging to the specific primary community, and a number of common users belonging to both the candidate community and the specific primary community;
(b) proximity of a K-dimensional saturation vector of the candidate community to a K-dimensional saturation vector of the specific primary community; or
(c) cross-correlation of the K-dimensional saturation vector of the candidate community to the K-dimensional saturation vector of the specific primary community.

According to an embodiment, a pairwise kinship level of the candidate community to the specific primary community is a composite kinship level determined as:

$${e}_{j , k} = {q}_{1} \times {g}_{1 , j , k} + {q}_{2} \times {g}_{2 , j , k} + {q}_{3} \times {g}_{3 , j , k} ;$$

0≤j<Γ, Γ≤k<H, H being a count of the total number of communities of the superset of communities, Γ being a count of the primary communities of the set of primary communities, indexed as 0 to (Γ−1).

The weighting factors q₁, q₂, and q₃ of the kinship coefficients g_{1,j,k}, g_{2,j,k}, and g_{3,j,k}; are prescribed; q₁+q₂+q₃=1.0.

The type-1 kinship coefficient, g_{1,j,k}, is based on a number of users belonging to the candidate community, a number of users belonging to the specific primary community, and a number of common users belonging to both the candidate community and the specific primary community.

The type-2 kinship coefficient, g_{2,j,k}, is based on proximity of the K-dimensional saturation vector of the candidate community to a K-dimensional saturation vector of the specific primary community.

The type-3 kinship coefficient, g_{3,j,k; k}, is based on cross-correlation of the K-dimensional saturation vector of the candidate community to the K-dimensional saturation vector of the specific primary community.

According to a further aspect, the invention provides a marketing inference engine comprising a first module for determining a superset of communities of users of a tracked population of users. Each community comprises users of a respective trait of a predetermined superset of predefined traits. A second module determines relevant traits for a specific commodity based on records of prior client transactions. A third module determines primary communities of the superset of communities corresponding to the relevant traits. A fourth module determines prospective clients based on at least the primary communities.

A fifth module determines a type-1 pairwise kinships of candidate communities of the superset of communities to the primary communities based on overlap of each candidate community with the primary communities. A sixth module selects secondary communities based on values of the type-1 pairwise kinship of candidate communities and supplies data relevant to the secondary communities to the fourth module for expanding the set of prospective clients to account for both the primary communities and the secondary communities.

A seventh module segments the population of users into a set of clusters according to individual characteristics of each user of the universe of users. An eighth module determines a saturation-score vector of each community of the superset of communities as a size of intersection of said each community with each cluster of the set of clusters. The module is configured to determine type-2 pairwise kinships of communities based on trait saturation within individual clusters of the set of clusters. Accordingly, type-2 pairwise kinship values of candidate communities of the superset of communities to the primary communities are determined based on proximity of a saturation-level vector of each candidate community to a respective saturation-level vector of each primary community.

The eighth module is further configured to determine type-3 pairwise kinships of candidate communities of the superset of communities to the primary communities based on cross-correlation of a saturation-level vector of each candidate community and a respective saturation-level vector of each primary community.

A ninth module determines secondary communities according to the type-2 pairwise kinships of communities, or the type-3 pairwise kinships of communities, and communicates data relevant to the secondary communities to the fourth module for expanding the set of prospective clients to account for both the primary communities and the secondary communities.

In accordance with yet another aspect of the invention, there is provided a marketing system, comprising: a processor; and a marketing inference engine, comprising a memory device having computer executable instructions stored thereon for execution by the processor, forming: a first module for determining a superset of communities of users, of a tracked population of users, wherein each community comprises users of a respective trait of a predetermined superset of predefined traits, a second module for determining relevant traits for a specific commodity based on records of prior client transactions, a third module for determining primary communities of the superset of communities corresponding to the relevant traits, and a fourth module for determining prospective clients based on at least the primary communities.

In accordance with one more aspect of the invention, there is provided a system for determining prospective clients for a specific commodity, comprising: a processor, a computer memory storing processor executable instructions thereon, for execution by the processor, causing the processor to: select a specific commodity from a list of commodities of interest, acquire data relevant to prior clients of the specific commodity, determine a set of relevant traits of the prior clients based on said data, the set of relevant traits belonging to a predefined superset of traits, determine a superset of communities of a universe of users, each community corresponding to a respective trait of the predefined superset of traits, select a set of primary communities, corresponding to the set of relevant traits, from the superset of communities, and determine a set of prospective clients comprising users belonging to the primary communities.

In accordance with yet one more another aspect of the invention, there is provided a system for advertising a specific commodity, comprising: a processor, a computer memory storing processor executable instructions thereon, for execution by the processor, causing the processor to: access a database indicating traits, of a predefined superset of traits, of each user of a population of users, determine a superset of communities, each community comprising users, of the population of users, possessing a respective trait of the predefined superset of traits, receive identifiers of a set of primary communities of interest belonging to the superset of communities, initialize a set of secondary communities as an empty set, for said each community, excluding said set of primary communities: determine a measure of kinship to the set of primary communities, and add said each community to the set of secondary communities subject to a determination that the measure of kinship exceeds a predefined level, and determine a set of prospective clients based on the set of primary communities and the set of secondary communities.

Thus, an improved marketing engine and a method therefor have been provided.

### BRIEF DESCRIPTION OF THE DRAWINGS

Embodiments of the present invention will be further described with reference to the accompanying exemplary drawings, in which:

FIG. 1 illustrates a marketing-inference system in accordance with an embodiment of the present invention;

FIG. 2 illustrates components of a filter of the marketing-inference system;

FIG. 3 illustrates a process for determining principal communities of users of relevant traits and extended communities of users of significant kinship to the principal communities, in accordance with an embodiment of the present invention;

FIG. 4 is a schematic of a fully configured marketing-inference engine, in accordance with an embodiment of the present invention;

FIG. 5 is a schematic of the principal segment (core) of marketing-inference engine;

FIG. 6 is a schematic of a first extension of the principal segment of the marketing-inference engine where target users (prospective clients) are determined according to both primary communities and secondary communities having a type-1 kinship to the primary communities;

FIG. 7 is a schematic of a second extension of the principal segment of the marketing-inference engine where target users (prospective clients) are determined according to both primary communities and secondary communities having a type-2 kinship to the primary communities or having a type-3 kinship to the primary communities;

FIG. 8 is a schematic of a third extension of the principal segment of the marketing-inference engine where target users (prospective clients) are determined according to both primary communities and secondary communities selected according to a composite kinship to the primary communities defined in terms of type-1, type-2, and type-3 kinships to the primary communities.

FIG. 9 is a schematic of a variation of marketing-inference engine of FIG. 4

FIG. 10 illustrates a process for determining primary traits, hence primary communities of users, based on prior demand for a specific commodity, in accordance with an embodiment of the present invention;

FIG. 11 illustrates a method of determining significant traits for a selected commodity, in accordance with an embodiment of the present invention;

FIG. 12 illustrates a first measure of trait-pair kinship, for use in an embodiment of the present invention;

FIG. 13 illustrates pairwise trait kinship according to the first measure of kinship;

FIG. 14 illustrates examples of determination of significant secondary traits based on the first measure of kinship

FIG. 15 illustrates communities of users of the universe of tracked users defined according to respective user traits;

FIG. 16 illustrates a universe of tracked users segmented into clusters based on characteristics of individual users;

FIG. 17 illustrates superposition of communities onto clusters, for use in an embodiment of the present invention;

FIG. 18 illustrates determining first-stratum communities of consumers of a specific commodity, in accordance with an embodiment of the present invention;

FIG. 19 illustrates determining a pairwise composite kinship as a weighted sum of corresponding type-1, type-2, and type-3 kinship levels, in accordance with an embodiment of the present invention;

FIG. 20 illustrates a first method of determining prospective clients for a commodity, in accordance with an embodiment of the present invention;

FIG. 21 illustrates associating at least one community of users with one user trait determined from a set of specific tracked users, in accordance with an embodiment of the present invention;

FIG. 22 illustrates associating at least two communities of users with two user traits determined from a set of specific tracked users, in accordance with an embodiment of the present invention;

FIG. 23 illustrates an example of four communities of users associated with two user traits determined from a set of specific tracked users, in accordance with an embodiment of the present invention;

FIG. 24 illustrates another example of four communities of users associated with two user traits determined from a set of specific tracked users, in accordance with an embodiment of the present invention;

FIG. 25 illustrates saturation levels of communities within clusters, for use in an embodiment of the present invention;

FIG. 26 illustrates a method of determining a second measure of trait-pair kinship based on proximity of trait saturation levels within clusters, in accordance with an embodiment of the present invention;

FIG. 27 illustrates a method of determining a third measure of trait-pair kinship based on cross-correlation of trait saturation levels within clusters, in accordance with an embodiment of the present invention;

FIG. 28 illustrates a method for determining trait-pair kinship for use in determining second-stratum communities of consumers of a specific commodity, in accordance with an embodiment of the present invention;

FIG. 29 illustrates a method of determining trait-pair kinship, in accordance with an embodiment of the present invention;

FIG. 30 illustrates a second method of determining prospective clients for a commodity, in accordance with an embodiment of the present invention;

FIG. 31 illustrates a table of inter-trait kinships (inter-community kinships), for use in an embodiment of the present invention;

FIG. 32 illustrates a pre-processing stage for determining clusters of users based on characteristics of users and communities of users based on traits of users, for use in an embodiment of the present invention;

FIG. 33 illustrates trait-pair kinship values of exemplary traits based on the kinship measures of FIG. 26 and FIG. 27;

FIG. 34 illustrates exemplary trait-saturation scores within a number of clusters;

FIG. 35 illustrates normalized trait-saturation levels corresponding to the trait-saturation scores of FIG. 24;

FIG. 36 illustrates a table of trait-saturation scores and a table of normalized trait-saturation levels corresponding to FIG. 34 and FIG. 35, respectively;

FIG. 37 illustrates pairwise trait-kinship values according to the kinship measure of FIG. 26 and the kinship measure of FIG. 27;

FIG. 38 further illustrates pairwise trait-kinship values of FIG. 37;

FIG. 39 illustrates trait-saturation patterns within a number of clusters of a first trait pair;

FIG. 40 illustrates trait-saturation patterns within a number of clusters of a second trait pair;

FIG. 41 illustrates trait-saturation patterns within a number of clusters of a third trait pair; and

FIG. 42 illustrates trait-saturation patterns within a number of clusters of a fourth trait pair.

### REFERENCE NUMERALS

100: Overview of a marketing-inference system
110: A commodity to promote
112: Data relevant to a population of tracked users considered a population of potential clients (potential consumers)
120: A marketing-inference engine
140: Relevant consumers data
160: A filter identifying prospective clients from the population of tracked users based on consumers traits associated with commodity 110
180: A module for determining prospective clients
200: Components of filter 160
210: Data memory devices
220: Memory storing acquired input data such as data relevant to tracked users
230: Memory storing computed intermediate data such as relevant users' traits, communities of users of common traits, and clusters of users formed according to characteristics of users
240: Memory storing data relevant to prospective clients
300: A schematic of a process for determining principal communities of users of relevant traits and extended communities of users of significant kinship to the principal communities
310: Compatible communities of users
320: Module for determining primary communities of users
340: Module for determining secondary communities of users
400: A schematic of the marketing-inference engine
410: Commodity-relevant data
411: A list of commodities to be promoted
412: Records of transactions of clients of each listed commodity
413: A superset of predefined traits considered to be determinants of consumer tendencies
414: Maintained data of tracked users of interest; for example, tracked social-media users
415: A set of predefined characteristics according to which a population is segments into distinct clusters
416: Population-relevant data
420: A module for determining relevant traits for a specific commodity
430: A module for determining a superset of communities of users where each community comprises users of a respective trait
440: A module for determining a set of clusters of users where each cluster comprises users of close characteristics
450: Pairwise kinship of communities of users based on common membership of a pair of communities
460: A module for determining pairwise kinships of communities based on common membership of a pair of communities
470: A module for determining pairwise kinships of communities based on trait saturation within individual clusters of the set of clusters formed in module 440
462: Module for determining secondary communities according to pairwise kinships of communities determined in module 460
472: Module for determining secondary communities according to pairwise kinships of communities determined in module 470
500: Schematic of the principal segment (core) of marketing-inference engine
520: An assembly of modules 420, 430, and 450 for determining relevant traits to a selected commodity
600: Schematic of a first extension of the principal segment of the marketing-inference engine where target users (prospective clients) are determined according to both primary communities and secondary communities having a type-1 kinship to the primary communities
620: An assembly of modules 460 and 462 for determining secondary communities based on a type-1 kinship of the set of primary communities determined in module 450 to other communities of the set of communities determined in module 430
700: Schematic of a second extension of the principal segment of the marketing-inference engine where target users (prospective clients) are determined according to both primary communities and secondary communities having a type-2 kinship to the primary communities or having a type-3 kinship to the primary communities
720: An assembly of modules 440, 470 and 472 for determining secondary communities based on a type-2 kinship or a type-3 kinship of the set of primary communities determined in module 450 to other communities of the set of communities determined in module 430
800: Schematic of a third extension of the principal segment of the marketing-inference engine where target users (prospective clients) are determined according to both primary communities and secondary communities selected according to a composite kinship to the primary communities defined in terms of type-1, type-2, and type-3 kinships to the primary communities.
820: An assembly of modules 440, 850 and 880 for determining secondary communities based on a composite kinship of the set of primary communities determined in module 450 to other communities of the set of communities determined in module 430
900: A schematic of a variation of marketing-inference engine 400
910: A list of commodities to be promoted together with known relevant traits for each commodity
920: An assembly of modules 430 and 450 for determining relevant traits to a selected commodity based on known relevant traits of prior clients of a specific commodity
1000: A process for determining primary traits, hence primary communities of users, based on prior demand for a specific commodity
1012: A specific user of the tracked users
1020: Membership count of each community of the set of communities 430, denoted W₀ to W₈, corresponding to traits T₀ to T₈
1030: A set of prior clients for a specific commodity
1032: A client typified as having traits T₀, T₄, T₅, and T₆ of the superset of predefined traits 413 denotes T₀ to T₈
1040: Initial trait score defined as a number of clients of the set 1030 of prior clients having a specific trait of the superset of predefined traits 413
1042: Prorated initial trait score determined according to a ratio of a trait score to membership count of a community corresponding to the trait
1045: First selected trait of highest prorated initial trait
1050: First adjusted trait score to account for common membership of each remaining trait with the first selected trait
1052: Prorated first-adjusted trait score determined as a ratio of a trait score to membership count of a community corresponding to the trait
1055: Second selected trait of highest prorated first-adjusted trait
1060: Second adjusted trait score to account for common membership of each remaining trait with the second selected trait
1062: Prorated second-adjusted trait score determined as a ratio of a trait score to membership count of a community corresponding to the trait
1065: Third selected trait of highest prorated second-adjusted trait
1100: A process for determining secondary traits, hence secondary communities of users, based on kinship of the primary communities (corresponding to the primary traits) to each of the remaining communities
1110: A selected commodity
1120: Candidate primary traits
1130: Measures of relevance of significant primary traits (denoted T₃, T₅, and T₆) to selected commodity 1110
1140: Candidate secondary trait (candidate primary traits excluding the significant primary traits)
1150: A measure of kinship of a significant primary trait to a candidate secondary trait
1160: A measure of kinship of a candidate secondary trait to the set of significant primary traits
1200: Pairwise trait kinship; a first measure of kinship of a second trait to a first trait
1210: A community of users determined to have the first trait
1220: A community of users determined to have the second trait
1215: Users belonging to both communities, i.e., intersection of community 1210 and community 1220
1230: A first definition of the first measure of kinship
1240: A second definition of the first measure of kinship
1250: A third definition of the first measure of kinship
1300: Examples of pairwise trait kinship according to the first measure
1310: First example of pairwise kinship
1320: Second example of pairwise kinship
1330: Third example of pairwise kinship
1400: Examples of determination of significant secondary traits based on the first measure of kinship
1500: Communities of users formed according to traits of individual users
1520: A community of users corresponding to a single trait
1600: Clusters of users formed according to characteristics of individual users
1620: Universe of tracked users
1700: Superposition of communities onto clusters
1800: First-stratum communities of users corresponding to a specific commodity
1810: Prior transactions data
1820: Significant traits corresponding to the specific commodity
1830: Communities of users having a one-to-one correspondence to the significant traits
1910: A table of pairwise type-1 kinship of candidate communities to primary communities
1920: A table of pairwise type-2 kinship of the candidate communities to the primary communities
1930: A table of pairwise type-3 kinship of the candidate communities to the primary communities
1940: A table of pairwise composite kinship of the candidate communities to the primary communities
1950: Indices of primary communities
1960: Indices of candidate communities
2000: A first method of determining prospective clients for a specific commodity
2010: A step of selecting a commodity from a list of commodities of interest
2020: A process of acquiring a set of tracked clients of the specific commodity
2030: A process of determining a set of significant first-stratum traits of the tracked clients
2050: A process of determining a union of communities of the significant first-stratum traits
2060: A process of communicating with the union of communities of the significant first-stratum traits
2100: An illustration of trait-defined users for a single significant trait
2110: A set of tracked users of a specific trait
2120: A community of users of the specific trait
2130: A set of first-stratum users of the specific trait
2140: A community of users of considerable kinship to community 2120
2141: A community of users of slight kinship to community 2120
2142: Another community of users of slight kinship to community 2120
2143: Another community of users of slight kinship to community 2120
2144: Another community of users of slight kinship to community 2120
2150: A set of first-stratum and second-stratum users of the specific trait
2200: A first illustration of trait-defined users for two significant traits
2210: A set of tracked users of a first trait
2212: A set of tracked users of a second trait
2220: Community of users of the first trait
2222: Community of users of the second trait
2230: A set of first-stratum users of the first and second traits
2240: A community of users of considerable kinship to community 2220
2241: A community of users of slight kinship to community 2220
2242: A community of users of considerable kinship to community 2222
2243: A community of users of slight kinship to community 1122
2250: A set of first-stratum and second-stratum users of the first and second traits
2300: A second illustration of trait-defined users for two significant traits
2310: A set of tracked users of a first trait
2312: A set of tracked users of a second trait
2320: Community of users of the first trait
2330: Community of users of the second trait
2340: A community of users of considerable kinship to community 2320
2350: A community of users of considerable kinship to community 2330
2360: A set of first-stratum and second-stratum users of the first and second traits
2400: A third illustration of trait-defined users for two significant traits
2450: A community of users of considerable kinship to community 1230
2460: A set of first-stratum and second-stratum users of the first and second traits
2500: Saturation levels of communities of users within a set of clusters
2510: A cluster of users
2520: A segment of a community of users within a cluster
2600: Illustration of a second measure of trait-pair kinship based on proximity of trait saturation levels within clusters
2610: Absolute value of a difference of saturation levels of two traits within a same cluster
2700: Illustration of a third measure of trait-pair kinship based on cross-correlation of trait saturation levels within clusters
2710: Trait-saturation pattern of a first trait within a set of clusters
2720: Trait-saturation pattern of a second trait within the set of clusters
2800: Method of determining trait-pair kinship
2810: A reference community of users corresponding to a specific trait and belonging to a specific first-stratum community of users for a specific commodity
2812: A candidate community of users
2820: A process of selecting a kinship criterion
2830: A process of determining common memberships of the reference community and the candidate community
2840: A process of determining saturation patterns of the reference community and candidate community within a set of user clusters
2832: A process of kinship evaluation based on common memberships of the reference community and the candidate community
2842: A process of kinship evaluation based on proximity of the saturation patterns of the reference community and the candidate community
2844: A process of kinship evaluation based on cross-correlation of the saturation patterns of the reference community and the candidate community
2850: A process of deciding whether to include or exclude the candidate community in a set of second-stratum communities of users relevant to the reference community.
2900: A method of determining trait-pair kinship
2910: Input data
2920: Identifier of a first trait
2921: Identifier of a second trait
2930: Process of acquiring (pre-computed) community of users of the first trait
2940: Process of acquiring (pre-computed) community of users of the second trait
2950: Process of determining kinship of the first and second traits
3000: A second method of determining prospective clients for a specific commodity
3040: A process of determining a set of significant second-stratum traits relevant to the set of first-stratum traits
3050: A process of determining a union of communities of significant traits
3060: A process of communicating with the union of communities of the significant traits
3100: Matrix of trait-pair kinship
3110: A first-trait identifier
3120: A second-trait identifier
3130: Kinship of a trait pair
3200: A pre-processing stage for determining clusters of users and communities of users
3270: Preprocessing module
3300: Trait-saturation patterns
3330: Pattern of normalized trait-saturation levels
3400: Exemplary trait-saturation scores within a number of clusters
3430: A pattern of trait-saturation scores
3500: Normalized trait-saturation levels
3530: A pattern of trait-saturation levels
3600: A table of trait-saturation scores
3620: A table of normalized trait-saturation levels
3630: Trait-saturation score
3640: Normalized trait-saturation level
3710: Pairwise trait-kinship values based on proximity of trait-saturation levels within clusters
3712: Kinship level based on proximity
3720: Pairwise trait-kinship values based on cross-correlation of trait-saturation levels within clusters
3722: Kinship level based on cross correlation
3800: Comparison of proximity-based and cross-correlation based kinship levels
3810: Kinship levels based on proximity of trait-saturation patterns
3820: Kinship levels based on cross correlation of trait-saturation patterns

### Terminology

User: The term denotes a member of any population of interest, such as a population under consideration for developing a marketing system for specific commodities or for conducting a study aiming at gaining insight for policy development. The population may include users of social media or respondents to surveys, among many other entities. The term refers to an individual, or any other automaton, to which attention is directed.

Universe of users: The terms “population of users” and “universe of users” are herein used synonymously.

Characteristics of a user: The characteristics of a user represent slowly-varying properties (such as wealth), quasi-static properties (such as height of an adult), and/or permanent attributes such as place of birth. The characteristics of a user may comprise numerous attributes represented as a vector.

Traits of a user: The traits of a user represent evolving properties, such as societal views, favourite entertainment or sport, etc.

Cluster: A population under consideration may be segmented into a number of clusters according to values of a predefined set of characteristics for each member of the population. The number of clusters may be predefined or determined automatically under specific constraints.

Community: Members of the population possessing a specific trait form a respective community. The number of communities equals the number of predefined traits of interest. A user belongs to a one cluster but may belong to numerous communities.

Saturation pattern of a community: The term refers to intersection of a community with a set of clusters. The saturation pattern of a community is also referenced as the saturation pattern of the trait corresponding to the community.

Saturation-score vector: The counts of users of a community within a number K of clusters (K>1) form a K-dimensional saturation-score vector of the community (also called saturation-score vector of the trait defining the community).

Saturation-level vector: The proportion of users of a community within a number K of clusters (K>1) form a K-dimensional saturation-level vector of the community (also called saturation-level vector of the trait defining the community).

Kinship: For each trait of a predefined superset of traits, a community of users determined to have the trait is identified based on analysis of data characterizing a population of users under consideration. A kinship level of two traits is determined according to the contents (memberships) of respective communities. According to a first measure of kinship, a pairwise kinship level is based on intersection (overlap) of two communities. According to a second measure of kinship, a pairwise kinship level is based on proximity of saturation vectors of the two communities within a predetermined set of user clusters. According to a third measure of kinship, a pairwise kinship level is based on cross-correlation of the saturation vectors of the two communities.

### DETAILED DESCRIPTION

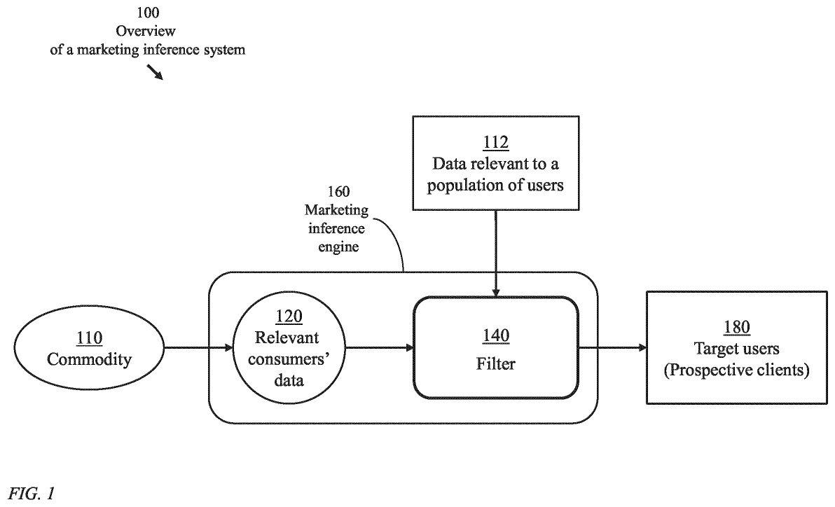

FIG. 1 illustrates a marketing-inference system 100 comprising a memory device having computer executable instructions stored thereon for execution by a hardware processor, forming a marketing-inference engine 160 configured to determine prospective clients 180 for a commodity (product or service) 110 from a population of users based on data 112 describing the population of users. The marketing engine 160 comprises a module 120 for determining relevant consumers' traits associated with commodity 110 and a filter 140 configured to identify prospective clients from the population of users based on consumers traits associated with commodity 110.

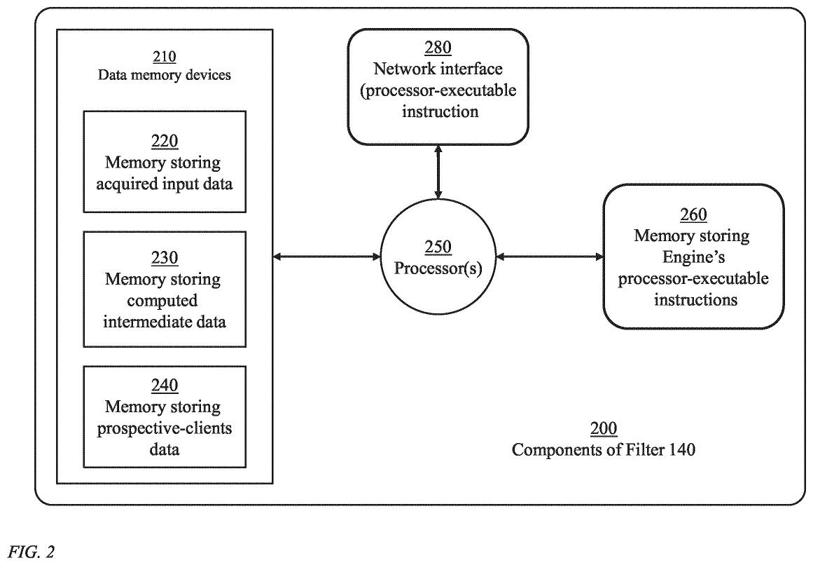

FIG. 2 illustrates components 200 of filter 140 of the marketing-inference engine 160. The filter comprises data memory devices 210, a network interface 280, a memory device 260 storing processor-executable instructions, and at least one hardware processor 250. The data memory devices 210 include:
a memory device 220 storing input data acquired from external sources such as data relevant to tracked users;
a memory device 230 storing computed intermediate data such as relevant users' traits, communities of users of common traits, and clusters of users formed according to characteristics of users; and
a memory device 240 storing data relevant to prospective clients.

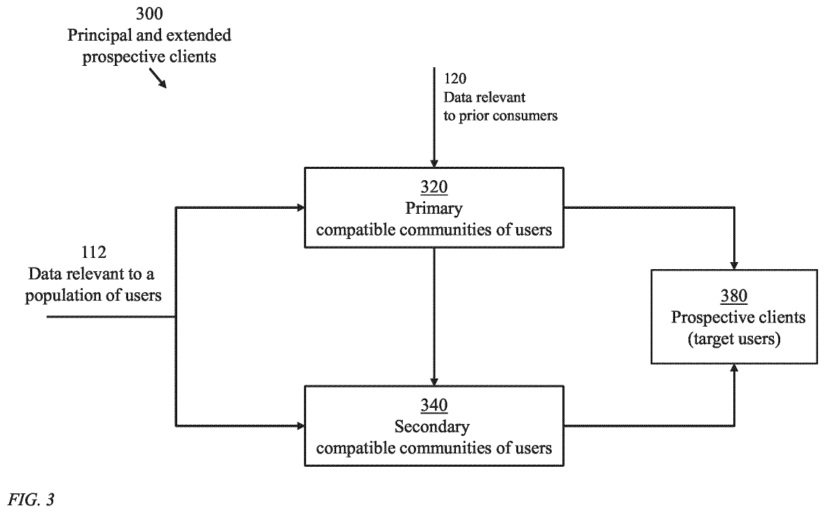

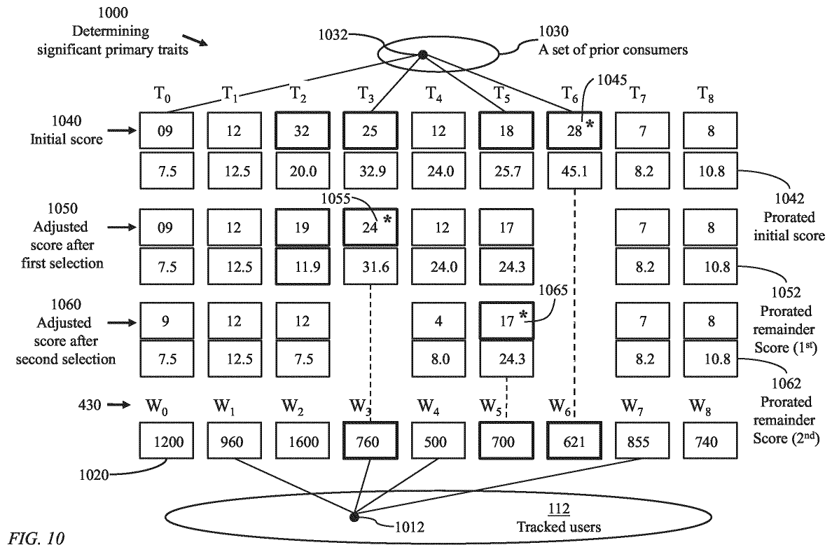

FIG. 3 depicts a schematic 300 of basic components of filter 140 for determining “primary communities” of users of relevant traits and “secondary communities” of users of significant kinship to the principal communities. To promote a specific commodity 110, specific user traits 140 compatible with the commodity are acquired. The specific user traits may be conjectured or determined from historical transaction data as described below with reference to FIG. 10.

Communities of users, of a population of tracked users, possessing the specific user traits would be considered likely future clients. Such communities of users are herein referenced as “primary communities” or “first-stratum” communities.

Communities of users, herein referenced as “secondary communities” or “second-stratum communities”, having significant kinship levels to the first-stratum communities of users may also be considered as likely future clients. Multi-stratum communities may likewise be considered with third-stratum communities of users having significant kinship to the second-stratum communities and so on. However, it may suffice to seek prospective clients 180 within the first-stratum and second-stratum communities.

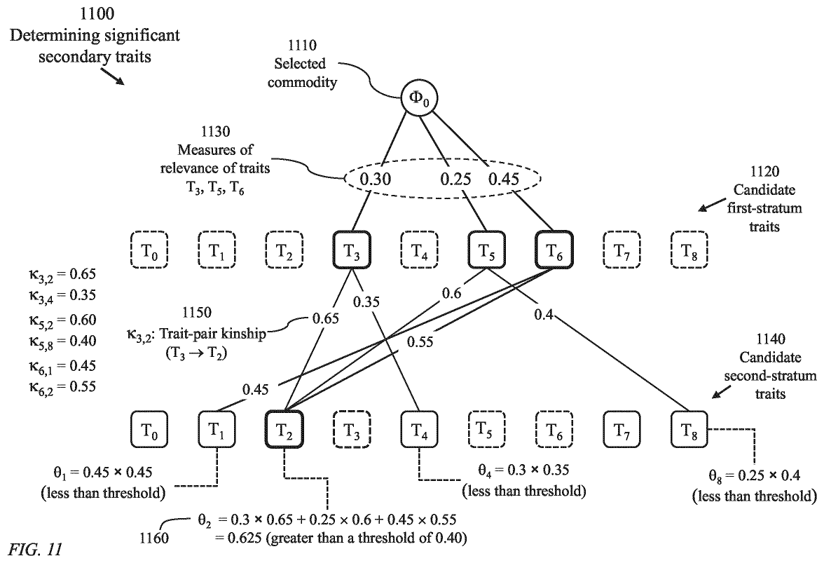

A module 320 determines the primary communities based on data 112 relevant to the population of users and the relevant user traits. A module 340 determines the secondary communities based on data 112 and the primary communities determined in module 320 as illustrated in FIG. 11. A module 380 determines prospective clients 180, In accordance with an implementation, prospective clients 180 may be based solely on the primary communities. In accordance with a preferred implementation, the prospective clients 180 are determined according to both the primary communities and the secondary communities.

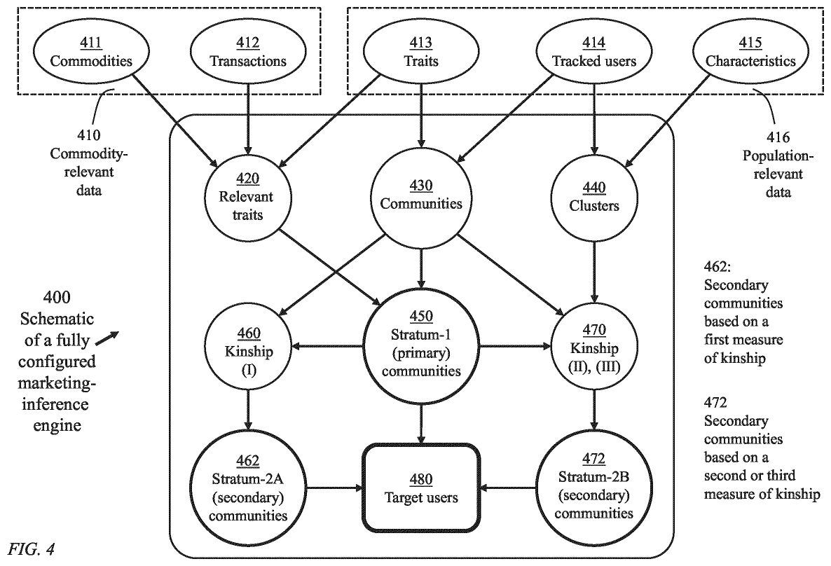

FIG. 4 is a schematic 400 of a marketing-inference engine configured to process commodity-relevant data 410 and population-relevant data 416 to produce data identifying prospective clients (target users) 180. The commodity-relevant data 410 comprise a list 411 of commodities to be promoted and records 412 of client transactions of each listed commodity.

The population-relevant data 416 comprise a superset 413 of predefined traits considered to be determinants of consumer tendencies, maintained (and regularly updated) data 414 of tracked users of interest (for example, tracked social-media users), and a set 415 of predefined characteristics according to which a population is segmented into distinct clusters.

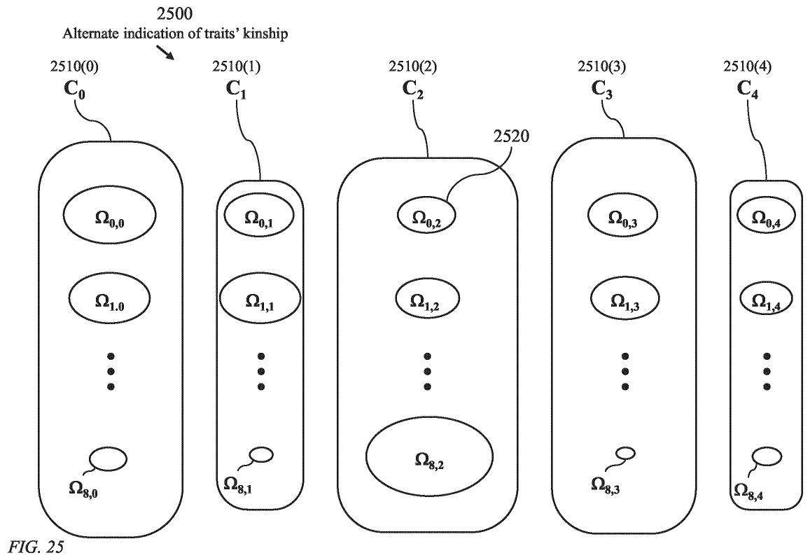

A fully-configured marketing-inference engine comprises:
(i) module 420 (an implementation of module 120 of FIG. 1) for determining relevant traits for a specific commodity of the list 411 of commodities based on records 412 of client transactions as described below with reference to FIG. 10;
(ii) module 430 for determining a set of communities of users where each community comprises users of a respective trait;
(iii) module 440 for determining a set of clusters of users where each cluster comprises users of close characteristics;
(iv) module 450 (an implementation of module 320 of FIG. 3) for determining the primary communities (first-stratum communities) based on the set of communities determined in module 430 and the relevant traits produced in module 420;
(v) module 460 for determining pairwise type-1 kinship of communities of users based on common membership of a pair of communities as detailed below with reference to FIGS. 11 to 14;
(vi) module 470 for determining pairwise type-2 and type-3 kinship of communities based on trait saturation within individual clusters of the set of clusters formed in module 440 as described below with reference to FIGS. 25 to 28;
(vii) module 462 (a first variation of module 340 of FIG. 3) for determining secondary communities (stratum-2A communities) based on the pairwise type-1 kinship of communities determined in module 460;
(viii) module 472 (a second variation of module 340 of FIG. 3) for determining secondary communities (stratum-2B communities) based on the pairwise type-2 and type-3 kinship of communities determined in module 470; and
(ix) module 480 for determining prospective clients (target users) based on the primary communities determined in module 450 and, optionally, stratum-2A or stratum-2B communities.

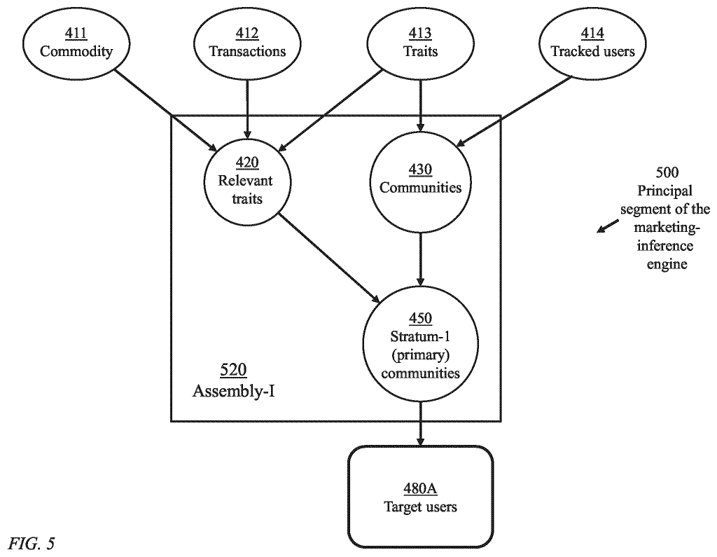

FIG. 5 is a schematic 500 of the principal segment (core) of the marketing-inference engine which determines prospective clients 180 based on the primary communities only. An assembly 520 (assembly-I) of modules 420, 430, and 450 processes records 412 of client transactions for a selected commodity of the list 411 of commodities to determine relevant traits to the selected commodity. The relevant traits belong to the predefined superset 413 of traits.

Module 480A determines a set of prospective clients (target users) based only on the primary communities of users determined in module 450. The set of prospective clients may be determined as the union of the primary communities of users. However, users belonging to an intersection of two or more primary communities may be considered more promising.

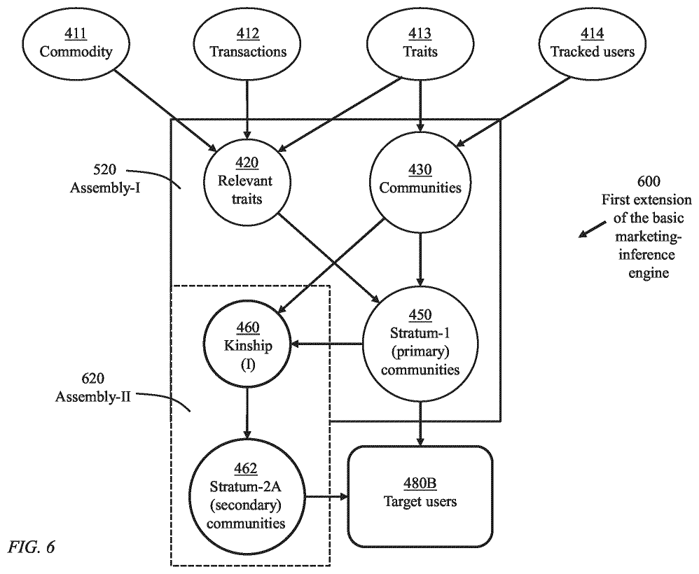

FIG. 6 is a schematic 600 of a first extension of the principal segment of the marketing-inference engine where target users (prospective clients) 180 are determined according to both primary communities and other communities having a type-1 kinship to the primary communities. Each community of the set of communities determined in module 430, excluding the primary communities determined in module 450, is a candidate for selection as a relevant secondary community.

An assembly 620 (assembly-II) of modules 460 and 462 determines secondary communities based on a type-1 kinship of the set of primary communities determined in module 450 to other communities of the set of communities determined in module 430 as described below with reference to FIGS. 11 to 14. A type-1 kinship is based on a count of common users of a community pair.

Module 480B determines a set of prospective clients (target users) based on the primary communities of users determined in module 450 and the secondary communities determined in module 462. The set of prospective clients may be determined as the union of the primary communities of users and the secondary community of users. However, users belonging to an intersection of two or more primary or secondary communities may be considered more promising.

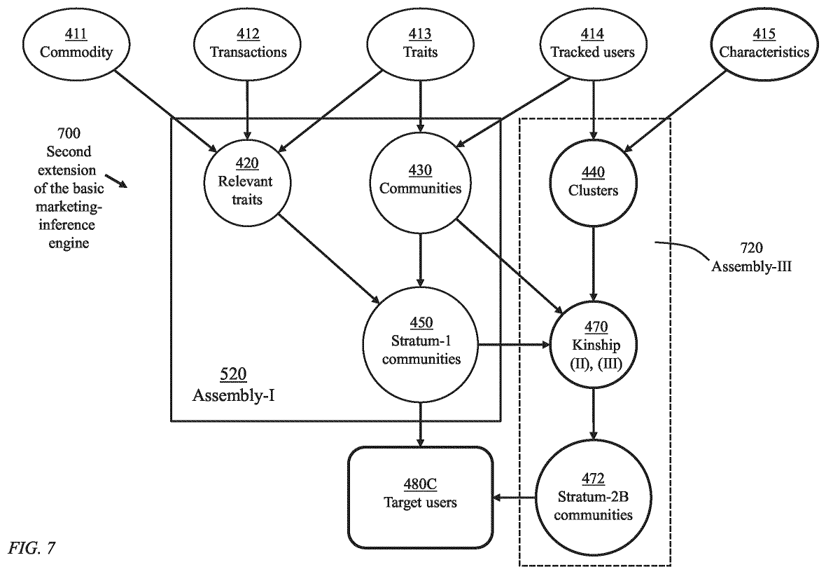

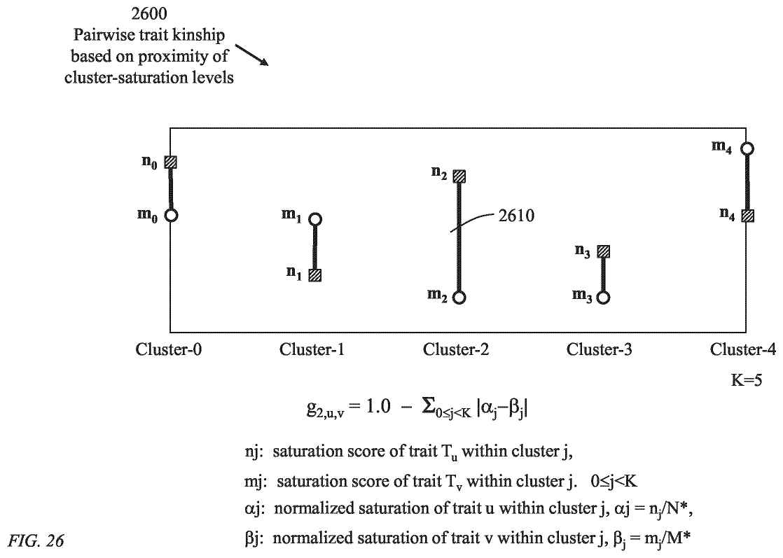

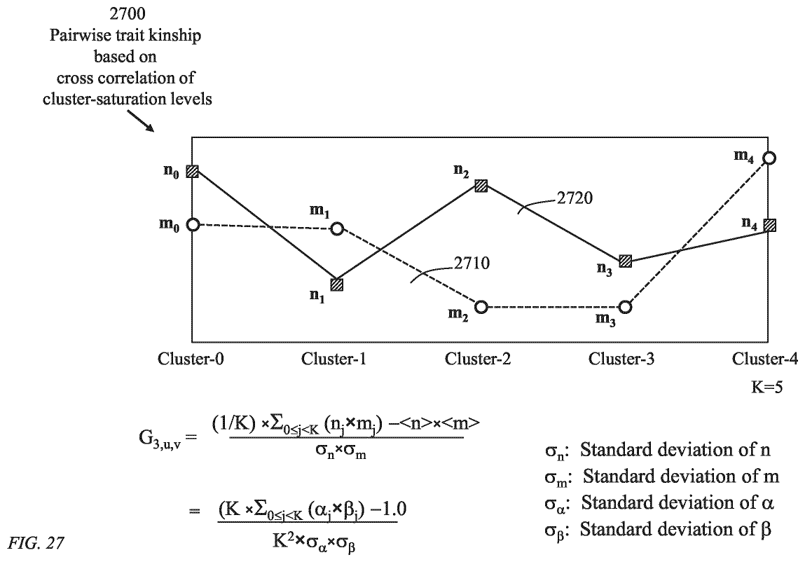

FIG. 7 is a schematic 700 of a second extension of the principal segment of the marketing-inference engine where target users (prospective clients) are determined according to both the primary communities and other communities having a type-2 kinship to the primary communities or a type-3 kinship to the primary communities. A type-2 kinship of two communities is based on proximity of intersection levels of each of the two communities with a set of clusters of users as illustrated in FIG. 25 and FIG. 26. A type-3 kinship of two communities is based on cross-correlation of intersection levels of each of the two communities with a set of clusters of users as illustrated in FIG. 25 and FIG. 27.

An assembly 720 (assembly-III) of modules 440, 470 and 472 determines secondary communities based on a type-2 kinship or a type-3 kinship of the set of primary communities determined in module 450 to other communities of the set of communities determined in module 430 as described below with reference to FIGS. 11 and 25 to 28.

Module 480C determines a set of prospective clients (target users) based on the primary communities of users determined in module 450 and the secondary communities determined in module 472. The set of prospective clients may be determined as the union of the primary communities of users and the secondary community of users. However, users belonging to an intersection of two or more primary or secondary communities may be considered more promising.

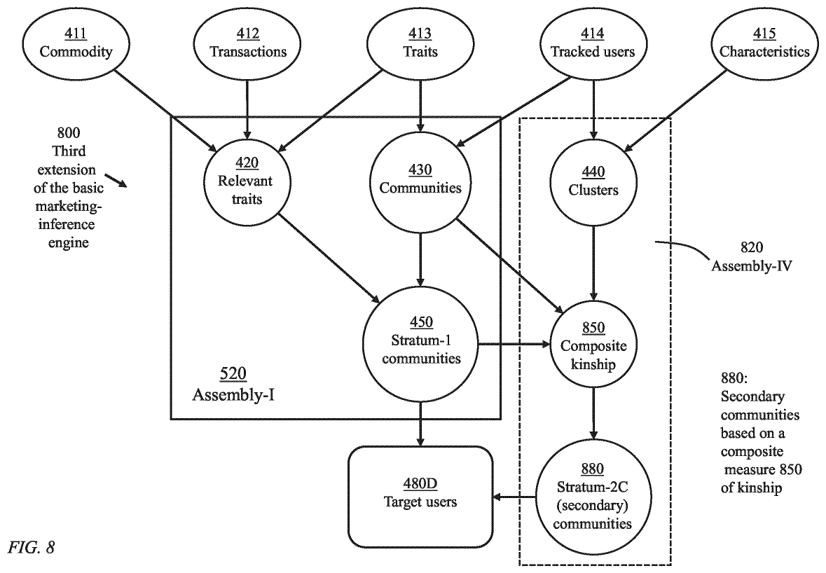

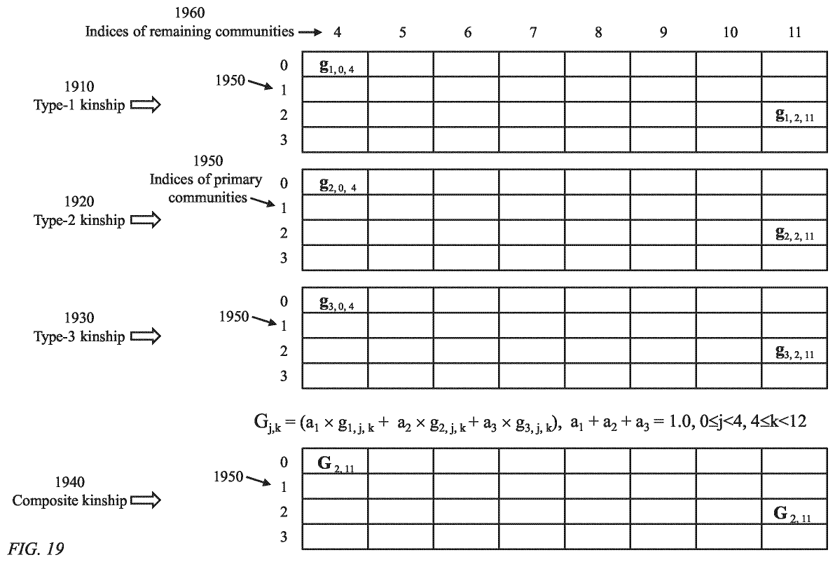

FIG. 8 is a schematic 800 of a third extension of the principal segment of the marketing-inference engine where target users (prospective clients) are determined according to both primary communities and secondary communities selected according to a composite kinship to the primary communities defined in terms of type-1, type-2, and type-3 kinships to the primary communities. Module 850 determines composite kinship of the set of primary communities determined in module 450 to other communities of the set of communities determined in module 430. Module 880 determines secondary communities based on the pairwise type-1, type-2 and type-3 kinship of communities determined in modules 460 and 470. Computation of a composite kinship is described below with reference to FIG. 19.

An assembly 820 (assembly-IV) of modules 440, 850 and 880 determines secondary communities based on type-1, type-2, and type-3 kinships of the set of primary communities determined in module 450 to other communities of the set of communities determined in module 430.

Module 480D determines a set of prospective clients (target users) based on the primary communities of users determined in module 450 and the secondary communities determined in module 880. The set of prospective clients may be determined as the union of the primary communities of users and the secondary community of users. However, users belonging to an intersection of two or more primary or secondary communities may be considered more promising.

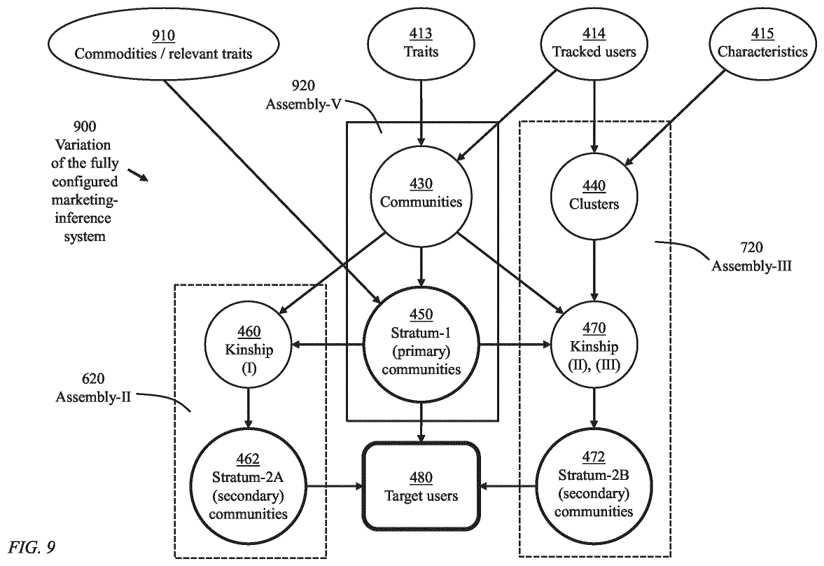

FIG. 9 is a schematic 900 of a variation of marketing-inference engine of FIG. 4 where relevant traits for a specific commodity are conjectured instead of being determined in module 420 from historical transaction data. A list 910 of commodities to be promoted together with known relevant traits for each commodity are acquired from appropriate sources. Thus, assembly-I of modules 420, 430, and 450 is reduced to assembly-V (reference 920) of modules 430, and 450.

Table-I below indicates a count of prior clients corresponding to each trait of a set of nine traits, denoted T₀ to T₈, to each commodity of set of Π, Π≥1, commodities denoted Φ₀ to Φ_{(Π-1)}. A simplified measure of relevance of a specific trait to a specific commodity may be based on a proportion of prior clients determined to have the specific trait. According to a straightforward approach, a trait is considered to be relevant to the specific commodity if the simplified measure of relevance exceeds a predefined threshold. For example, with a sample of 100 prior clients of commodity Φ₀, trait T₁ has a relevance score of 68, traits T₅ has a relevance score of 57, trait T₄ has a relevance score of 7, and trait T₇ has a relevance score of 2. The sum of the scores exceeds 100 because a client may be determined to have multiple traits. Traits T1, T4, T5, and T7 have simplified measures of relevance of 0.68, 0.07, 0.57, and 0.02, respectively. With a predefined threshold of 0.2, for example, only Traits T₁ and T₅ are considered and given normalized relevance levels of 68/(68+57) and 57/(68+57); that is 0.544 and 0.456, respectively.

TABLE I
Score of prior clients corresponding to each trait

| Community | Trait identifier | | | | | | | | |
|---|---|---|---|---|---|---|---|---|---|
| identifier | T₀ | T₁ | T₂ | T₃ | T₄ | T₅ | T₆ | T₇ | T₈ |
| Φ₀ | 0 | 68 | 0 | 0 | 7 | 57 | 0 | 2 | — |

.
.
.

Φ_{(Π-1)}

FIG. 10 illustrates a process 1000 for determining primary traits, hence primary communities of users, based on prior demand for a specific commodity. An exemplary superset 413 (FIG. 4) of predefined traits comprises nine traits denoted T₀ to T₈. The sizes 1020 of corresponding communities W₀ to W₈ (reference 430, FIG. 4) are determined from data 112 (FIG. 1) relevant to a population of tracked users. A tracked user may belong to multiple communities. The illustrated user 1012, having traits T₁, T₃, T₄, and T₇, belongs to communities W₁, W₃, W₄, and W₇.

Data, such as sales transactions, relevant to a set 1030 of prior clients for a specific commodity may be used to determine primary traits relevant to the specific community. Traits of each client of the set of prior clients are determined from records 412 of transactions of clients of each listed commodity. The illustrated client 1032 is typified as having traits T₀, T₄, T₅, and T₆ of the superset of predefined traits 413 denotes T₀ to T₈. An initial trait score 1040 of each of the traits T₀ to T₈, of the superset of predefined traits 413 is determined as a number of clients of the set 1030 of prior clients having a specific trait. In order to properly compare relevance of individual traits to a specific commodity, the initial trait scores 1040 for traits T₀ to T₈ are prorated to a nominal community size to produce prorated initial scores 1042. The nominal community size is selected to be 1000 in the example of FIG. 10. Thus, a raw score Sj of trait Tj, 0≤j<9, is prorated to ((1000×Sⱼ)/Qⱼ), Qⱼ being the size of community Wⱼ for Sj≤Qⱼ or prorated to the nominal community size if Sj>Qⱼ.

Trait T₆, having the highest prorated initial score of 45.1, is considered the most relevant trait and is the first selected trait 1045. Since a client of the set 1030 of prior clients for the specific commodity may have multiple traits, a first-adjusted trait score 1050 which accounts for common membership of each remaining trait with the first selected trait is produced. The initial score 1040 of each of the traits, excluding T₆, may be adjusted to exclude users already included in the initial score of T₆. Trait T₂ has an initial score of 32 clients of which 13 clients are also counted in the initial score of T₆. Thus, the score of T₂ is reduced from 32 to 19. Trait T₃ has an initial score of 25 clients of which one client is also counted in the initial score of T₆. Thus, the score of T₃ is reduced from 25 to 24. Trait T₅ has an initial score of 18 clients of which one client is also counted in the initial score of T₆. Thus, the score of T₅ is reduced from 18 to 17.

The first-adjusted trait score 1050 of each remaining trait is prorated to the aforementioned nominal community size to produce a prorated first-adjusted trait 1052. Thus, a first-adjusted score S⁽¹⁾ⱼ of trait Tj, 0≤j<9, j≠6, is prorated to ((1000×S⁽¹⁾ⱼ)/Qⱼ), Qⱼ being the size of community Wⱼ. Trait T₃, having the highest prorated first-adjusted trait 1052 of 31.6, is then the second selected trait 1055.

The first-adjusted score 1050 of each of the traits, excluding T₆ and T₃, may be adjusted again to exclude users already included in the first-adjusted score of T₃ to produce a second-adjusted trait score 1060. Trait T₂ has a first-adjusted score of 19 clients of which 7 clients are also counted in the first-adjusted score of T₃. Thus, the score of T₂ is reduced again from 19 to 12. Trait T₅ has a first-adjusted score of 17 clients none of which is counted in the first-adjusted score of T₃.

The second-adjusted trait score 1060 of each remaining trait is prorated to the aforementioned nominal community size to produce a prorated second-adjusted trait 1062. Thus, a second-adjusted score S⁽²⁾ⱼ of trait Tj, 0≤j<9, j≠6, j≠3, is prorated to 1000×(S⁽²⁾ⱼ/Qⱼ), Qⱼ being the size of community Wⱼ. Trait T₅, having the highest prorated second-adjusted trait 1062 of 24.3, is then the third-selected trait 1065.

Thus, to determine a set of relevant traits, module 420 (FIG. 4) acquires the size of each community of the superset of communities, initializes a set of relevant traits as an empty set, and determines for each trait of the superset of predefined traits a respective trait score as a number of clients of the set of prior clients determined to have the trait. Module 420 iteratively performs processes of:
(i) prorating each trait score to a nominal community size to produce prorated initial scores;
(ii) transferring a particular trait of highest prorated score to the set of relevant traits; and
(iii) adjusting the score of each of the remaining traits of the superset of predefined traits to exclude users already included in the particular trait.

The processes of FIG. 10 may continue until all predefined traits are ranked with respect to the specific commodity under consideration, or until the highest score of the remaining traits is below a predefined level.

FIG. 11 illustrates a method 1100 of determining significant traits for a selected commodity 1110, labeled Φ₀ for the case of nine predefined traits (H=9). Initially, each of the nine traits is a candidate for selection as a first-stratum trait 1120. A measure of relevance of each of the nine traits to the selected commodity is determined based on conjecture or based on analysis of tracked transaction data as described above with reference to FIG. 10. Only a measure of relevance above a predefined threshold is considered. The sum of the considered measures of relevance of all candidate traits to the selected commodity is normalized to unity.

In the example of FIG. 11, the measures 1130 of direct relevance of traits T₆, T₃, and T₅ to commodity Φ₀ are determined as 0.45, 0.30, and 0.25, respectively. With a predetermined threshold of direct relevance of 0.2, the measures of direct relevance of the remaining traits 1140 to the commodity Φ₀ are insignificant. The users belonging to communities W₆, W₃, and W₅, corresponding to traits T₆, T₃, and T₅, are treated as the primary users of interest with respect to commodity Φ⁰.

Each of the remaining traits {T₀, T₁, T₂, T₄, T₇, T₈} (reference 1140) is a candidate for selection as a second-stratum trait. A pairwise kinship value of each selected first-stratum trait to each of the remaining traits {T₀, T₁, T₂, T₄, T₇, T₈} is determined. Only candidate second-stratum traits each having pairwise kinship values above a predefined kinship threshold are considered. The sum of the kinship values of all considered candidate second-stratum traits with respect to a first-stratum trait is normalized to unity. As illustrated, first-stratum trait T₃ has a kinship value of 0.65 to T₂ and a kinship value of 0.35 to T₄. First-stratum trait T₅ has a kinship value of 0.6 to T₂ and a kinship value of 0.4 to T₈. First-stratum trait T₆ has a kinship value of 0.45 to T₁ and a kinship value of 0.55 to T₂.

A compound relevance value θⱼ of a candidate second-stratum trait Tⱼ, where Tⱼ is one of candidate second-stratum traits {T₀, T₁, T₂, T₄, T₇, T₈} is determined according to the relevance measures of selected first-stratum traits {T₃, T₅, T₆} and kinship values of candidate second-stratum trait Tⱼ to respective first-stratum traits. As indicated in FIG. 11, the values of the compound relevance θ₂, θ₄, and θ₈, for T₂, T₄, and T₈ are 0.2025, 0.6250, and 0.10, respectively.

Upon determining a set of Γ first-stratum traits, 0<Γ<H, a weighted aggregate kinship of each of the remaining (H-Γ) traits to the set of Γ first-stratum traits is determined. A remaining trait having an aggregate kinship exceeding a predefined threshold is qualified as a second-stratum trait. Table-II below illustrates the case of FIG. 11 of three first-stratum traits (Γ=3) of indices 6, 3, and 5, having relevance coefficients of 0.45, 0.30, and 0.25, respectively, to commodity Φ₀.

TABLE II
Aggregate kinship of candidate second-stratum communities
First-stratum communities

| | Index j | | | |
|---|---|---|---|---|
| | 6 | 3 | | 5 |
| ηⱼ | 0.45 | 0.30 | | 0.25 |
| Candidate second-stratum communities | | | | |
| | Pairwise kinship coefficient Λ_{j, k} | | | Aggregate |
| Index k | (type-1 kinship, for example) | | | kinship: |
| 0 | | | | |
| 1 | 0.45 | | | 0.2025 |
| 2 | 0.55 | 0.65 | 0.6 | 0.5925 |
| 3 | | | | |
| 4 | | 0.35 | | 0.105 |
| 5 | | | | |
| 6 | | | | |
| 7 | | | | |
| 8 | | | 0.4 | 0.10 |

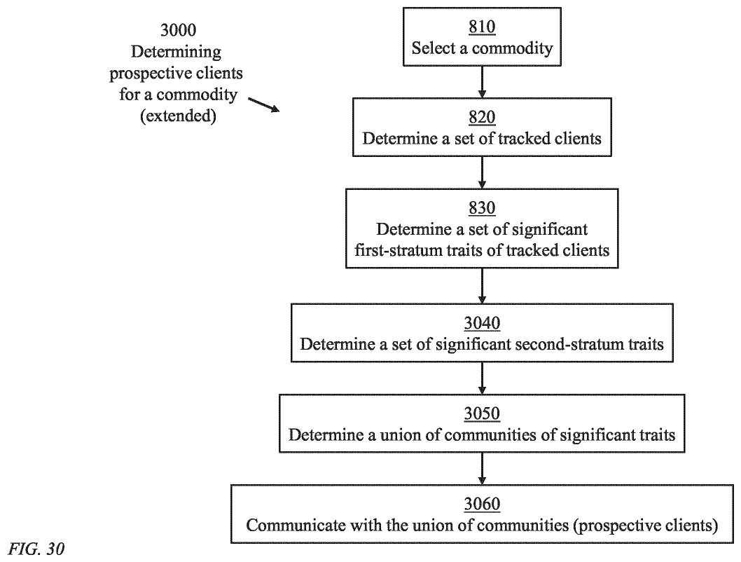

Setting a threshold of compound relevance to be 0.4, only trait T₂ would be accepted as second-stratum traits. According to the method of FIG. 30, the users belonging to communities W₃, W₅, W₆ and W₂, corresponding to traits T₃, T₅, T₆, and T₂, are treated as communities of interest with respect to commodity Φ₀.

With ηⱼ denoting a relevance coefficient of a first-stratum community of index j, and Λⱼ,k denoting pairwise kinship of a candidate community of index k to a first-stratum community of index j, a weighted aggregate kinship of the candidate of index k, to the set of first-stratum traits is determined as:

$${{Λ}_{k}}^{*} = {Σ}_{j} ( {η}_{j} \times {Λ}_{j . k} ) = ( {η}_{3} \times {Λ}_{3. k} + {η}_{5} \times {Λ}_{5. k} + {η}_{6} \times {Λ}_{6. k} )$$

With η₃=0.30, η₅=0.25, and η₆=0.45, the weighted aggregate kinship of candidate traits T₁, T₂, T₄, and T₈ (hence candidate communities W₁, W₂, W₄, and W₈) are determined as:

$${{Λ}_{1}}^{*} = {η}_{6} \times {Λ}_{6.1} = 0.45 \times 0.45 ;$$

$${{Λ}_{2}}^{*} = ( {η}_{3} \times {Λ}_{3.2} + {η}_{5} \times {Λ}_{5.2} + {η}_{6} \times {Λ}_{6.2} ) = 0.30 \times 0.65 + 0.25 \times 0.6 + 0.45 \times 0 .55 ;$$

$${{Λ}_{4}}^{*} = {η}_{3} \times {Λ}_{3.4} = 0.3 \times 0.35 ; and$$

$${{Λ}_{8}}^{*} = {η}_{5} \times {Λ}_{5.8} = 0.25 \times 0.4 .$$

Table-III below depicts aggregate kinship of candidate second-stratum communities for type-1 kinship, type-2 kinship, and type-3 kinship.

TABLE III
Kinship values of candidate secondary traits to a set of primary traits

| Kinship | Primary | | Candidate secondary traits | | | | | |
|---|---|---|---|---|---|---|---|---|
| type | traits | Relevance | T₀ | T₁ | T₂ | T₄ | T₇ | T₈ |
| Type-1 | T3 | 0.30 | — | — | 0.65 | 0.35 | — | — |
| | T5 | 0.25 | — | — | 0.60 | — | — | 0.40 |
| | T6 | 0.45 | — | 0.45 | 0.55 | — | — | — |
| Aggregate kinship | | | — | 0.2025 | 0.5925 | 0.1050 | — | 0.1000 |
| Type-2 | T3 | 0.30 | — | — | 0.58 | 0.42 | — | — |
| | T5 | 0.25 | — | — | 0.56 | — | — | 0.44 |
| | T6 | 0.45 | — | 0.50 | 0.50 | — | — | — |
| Aggregate kinship | | | — | 0.225 | 0.539 | 0.126 | — | 0.110 |
| Type-3 | T3 | 0.30 | — | — | 0.62 | 0.38 | — | — |
| | T5 | 0.25 | — | — | 0.59 | — | — | 0.41 |
| | T6 | 0.45 | — | 0.48 | 0.52 | — | — | — |

| | | | | | | |
|---|---|---|---|---|---|---|
| Aggregate kinship | — | 0.216 | 0.5675 | 0.114 | — | 0.1025 |

A composite pairwise kinship level or a composite aggregate kinship level may be determined according to kinship values corresponding to type-1, type-2, and type-3 kinship levels as described below with reference to FIG. 19.

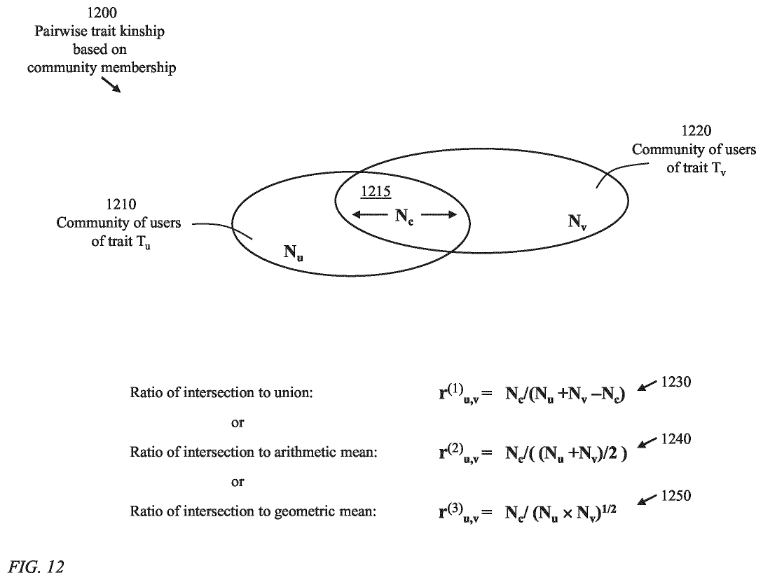

FIG. 12 illustrates a first measure 1200 of trait-pair kinship. Upon identifying a community 1210, denoted Wᵤ, of Nᵤ users of a first trait Tᵤ, and a community 1220, denoted Wᵥ, of Nᵥ users of a second trait T_{V}, the number N_{c} of common members 1215 is determined.

The first measure of kinship is based on the intersection of communities Wᵤ, and Wᵥ, i.e., the number of users belonging to both communities. According to a first form r⁽¹⁾_{u,v} of the first measure, kinship is determined as the ratio of the number of common users of the two communities to the number of users of the union of the communities (reference 1230). According to a second form r⁽²⁾_{u,v} of the first measure, kinship is determined as the ratio of the number of common users of the two communities to the arithmetic mean of the number of users of the first community and the number of users of the second community (reference 1240). According to a third form r⁽³⁾_{u,v} of the first measure, kinship is determined as the ratio of the number of common users of the two communities to the geometric mean of the number of users of the first community and the number of users of the second community (reference 1250). The number of users of the union of the two communities is (Nᵤ+Nᵥ−N_{c}). The arithmetic mean is (Nᵤ+Nᵥ)/2. The geometric mean is (Nᵤ+Nᵥ)^{1/2}. Thus:

$${{r}^{( 1 )}}_{u , v} = {N}_{c} / ( {N}_{u} + {N}_{v} - {N}_{c} ) ; \\ {{r}^{( 2 )}}_{u , v} = 2 \times {N}_{c} / ( {N}_{u} + {N}_{v} ) ; and \\ {{r}^{( 3 )}}_{u , v} = {N}_{c} / {( {N}_{u} + {N}_{v} )}^{1 / 2} . \qquad$$

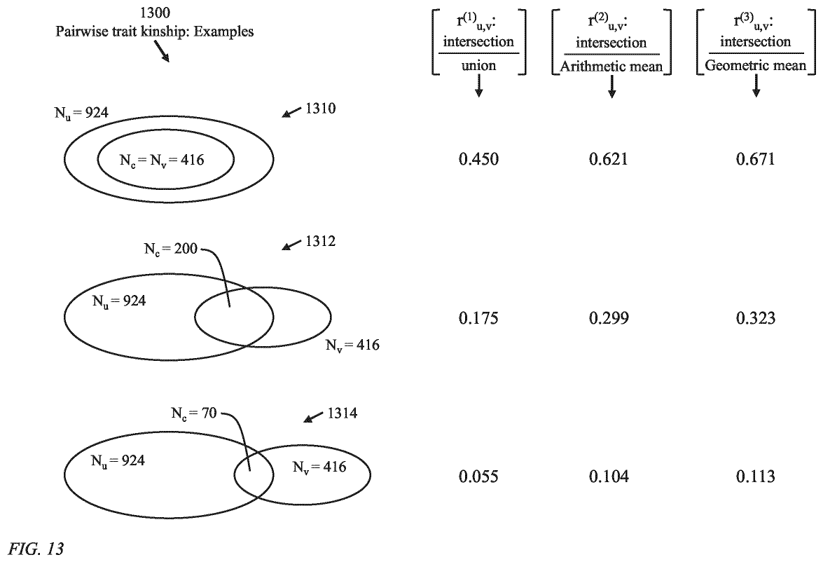

FIG. 13 illustrates examples 1300 of pairwise trait kinship according to the first measure of kinship with Nᵤ=924 and Nᵥ=416.

If all members of community Wᵥ are also members of community Wᵤ, (reference 1310), with Nᵤ>Nᵥ, then N_{c}=Nᵥ and:

$${{r}^{( 1 )}}_{u , v} = {N}_{c} / ( {N}_{u} + {N}_{v} - {N}_{c} ) = {N}_{c} / {N}_{u} = 0 .45 ; \\ {{r}^{( 2 )}}_{u , v} = 2 \times {N}_{c} / ( {N}_{u} + {N}_{v} ) = 0.621 ; and \\ {{r}^{( 3 )}}_{u , v} = {N}_{c} / {( {N}_{u} + {N}_{v} )}^{1 / 2} = 0.6 \; 11 . \qquad$$

With an intersection of 200 common members, i.e., N_{c}=200, (reference 1312), then:

$${{r}^{( 1 )}}_{u , v} = 0.175 ; \\ {{r}^{( 2 )}}_{u , v} = 0.299 ; \\ {{r}^{( 3 )}}_{u , v} = 0.323 . \qquad$$

With an intersection of 70 common members, i.e., N_{c}=70, (reference 1314), then:

$${{r}^{( 1 )}}_{u , v} = 0.055 ;$$

$${{r}^{( 2 )}}_{u , v} = 0.104 ;$$

$${{r}^{( 3 )}}_{u , v} = 0113.$$

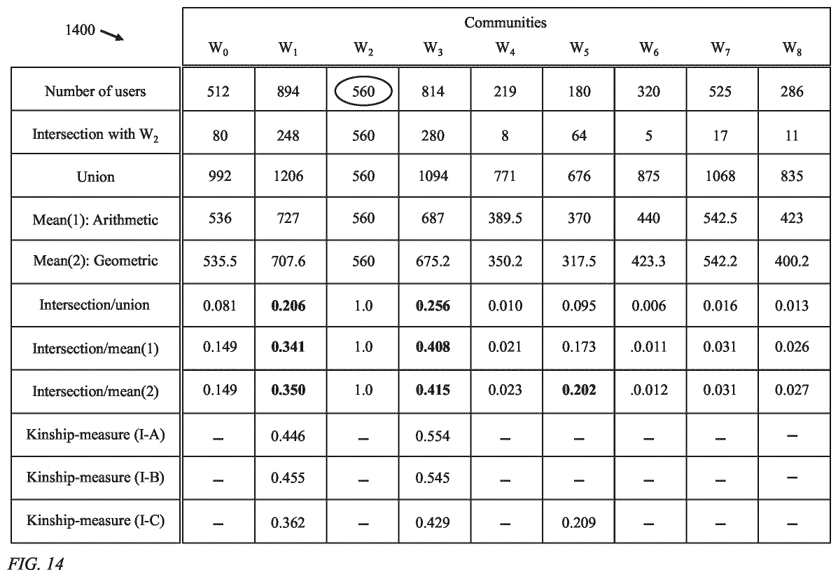

FIG. 14 illustrates examples 1400 of determination of kinship of each trait of a set of nine traits to a reference trait. The traits are indexed as (0) to (8), and corresponding communities are likewise indexed. The traits are denoted T₀ to T₈, and corresponding communities are labeled W₀ to W₈. The trait of index (2) is selected as a reference trait. The size of each community is determined and the intersection of each community with the reference community of index (2) is determined. The size of a community is the number of users determined to have a corresponding trait and the size of intersection of two communities is the number of users belonging to the two communities. The sizes of the nine communities and the intersection of each community with the reference community are determined.

The size of the community W₀ is 512, the size of the reference community W₂ is 560. The number of users belonging to communities W₀ and W₂ is 80. Thus, the size of the union of W₀ and W₂ is (512+560−80), which is 992. The arithmetic mean of the sizes of the two communities is 536 and the geometric mean of the sizes of the two communities is determined as (512+560)^{1/2}, which is 535.5. Thus,

$${{r}^{( 1 )}}_{0 , 2} = 80 / 9 \; 92 ; \\ {{r}^{( 2 )}}_{0 , 2} = 80 / 5 \; 36 ; \\ {{r}^{( 3 )}}_{0 , 2} = 80 / 535.5 . \qquad$$

Likewise, the values r⁽¹⁾_{j,2}, r⁽²⁾_{j,2}, r⁽³⁾_{j,2}, for j=1, 3, 4, 5, 6, 7, and 8 are determined. Only a kinship value above a prescribed lower bound are retained. In the example of FIG. 14, the lower bound is set to be 0.2. Accordingly, the retained values are:

r⁽¹⁾_{1,2} and r⁽¹⁾_{3,2},(0.206 and 0.256,respectively),

r⁽²⁾_{1,2} and r⁽²⁾_{3,2},(0.341 and 0.408,respectively), and

r⁽³⁾_{1,2},r⁽³⁾_{3,2}, and r⁽³⁾_{5,2},(0.350, 0.415, and 0.202,respectively).

The sum of kinship measures is normalized to unity. Thus, the corresponding normalised kinship measures are:

$${{κ}^{( 1 )}}_{1 , 2} = {{r}^{( 1 )}}_{1 , 2} / ( {{r}^{( 1 )}}_{1 , 2} + {{r}^{( 1 )}}_{3 , 2} ) = 0.446 ; \\ {{κ}^{( 1 )}}_{3 , 2} = {{r}^{( 1 )}}_{3 , 2} / ( {{r}^{( 1 )}}_{1 , 2} + {{r}^{( 1 )}}_{3 , 2} ) = 0.554 ; \\ {{κ}^{( 2 )}}_{1 , 2} = {{r}^{( 2 )}}_{1 , 2} / ( {{r}^{( 2 )}}_{1 , 2} + {{r}^{( 2 )}}_{3 , 2} ) = 0.455 ; \\ {{κ}^{( 2 )}}_{3 , 2} = {{r}^{( 2 )}}_{3 , 2} / ( {{r}^{( 2 )}}_{1 , 2} + {{r}^{( 2 )}}_{3 , 2} ) = 0.545 ; \\ {{κ}^{( 3 )}}_{1 , 2} = {{r}^{( 3 )}}_{1 , 2} / ( {{r}^{( 3 )}}_{1 , 2} + {{r}^{( 3 )}}_{3 , 2} + {{r}^{( 3 )}}_{5 , 2} ) = 0.362 ; \\ {{κ}^{( 3 )}}_{3 , 2} = {{r}^{( 3 )}}_{3 , 2} / ( {{r}^{( 3 )}}_{1 , 2} + {{r}^{( 3 )}}_{3 , 2} + {{r}^{( 3 )}}_{5 , 2} ) = 0.429 ; and \\ {{κ}^{( 3 )}}_{5 , 2} = {{r}^{( 3 )}}_{5 , 2} / ( {{r}^{( 3 )}}_{1 , 2} + {{r}^{( 3 )}}_{3 , 2} + {{r}^{( 3 )}}_{5 , 2} ) = 0 .209 . \qquad$$

If the lower bound is set to be 0.4 instead of 0.20, then the retained values of the third form of type-kinship would be r⁽³⁾_{1,2} and r⁽³⁾_{3,2}, (0.350 and 0.415, respectively), with corresponding normalised kinship measures of:

$${{κ}^{( 3 )}}_{1 , 2} = {{r}^{( 3 )}}_{1 , 2} / ( {{r}^{( 3 )}}_{1 , 2} + {{r}^{( 3 )}}_{3 , 2} ) = 0.458 ; and$$

$${{κ}^{( 3 )}}_{3 , 2} = {{r}^{( 3 )}}_{3 , 2} / ( {{r}^{( 3 )}}_{1 , 2} + {{r}^{( 3 )}}_{3 , 2} ) = 0.542 .$$

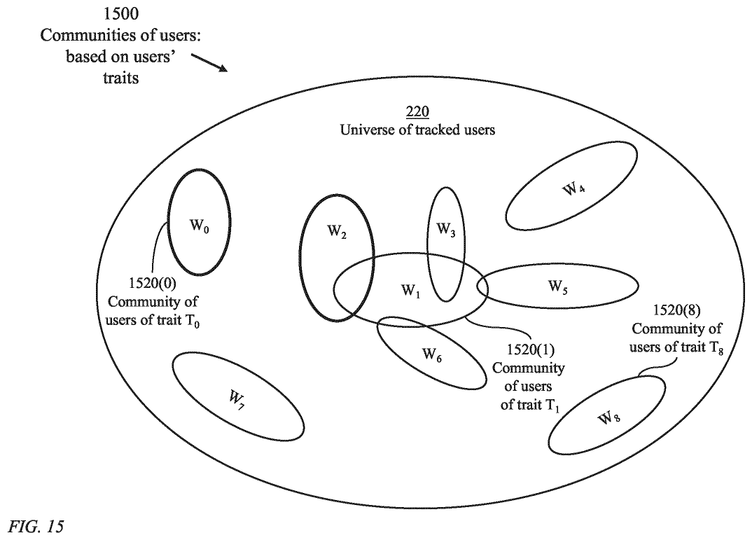

FIG. 15 illustrates a number of communities 1500 of users of the universe 430 of tracked users formed according to a number, H, of predefined significant traits of individual users. Nine communities 1520(0) to 1520(8) corresponding to nine traits (H=9) of interest, denoted T₀ to T₈, are defined. The communities are labeled W₀ to W₈. Each community corresponds to a single trait. A user may have more than one trait. Thus, a community may intersect other communities.

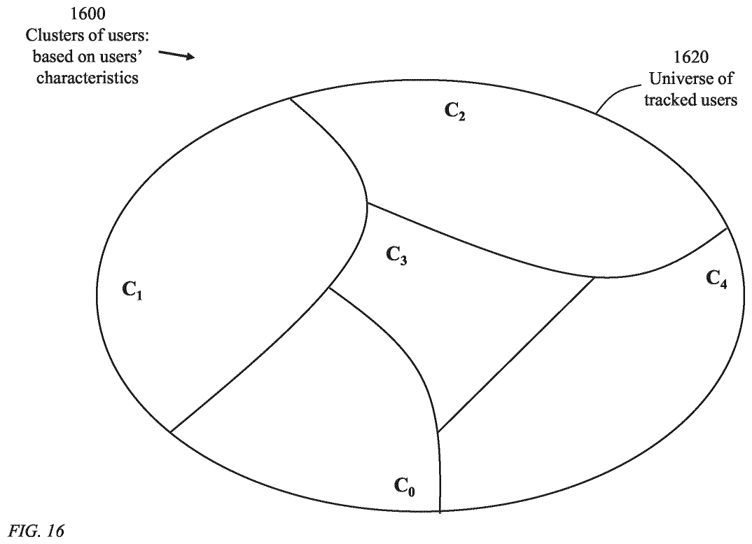

FIG. 16 illustrates a universe 1620 of tracked users segmented into K clusters 1600 based on characteristics of individual users, K>1. Five clusters (K=5) labeled C₀, C₁, C₂, C₃, and C₄ are defined in the example of FIG. 16 with each user of the universe of tracked users belonging to only one cluster.

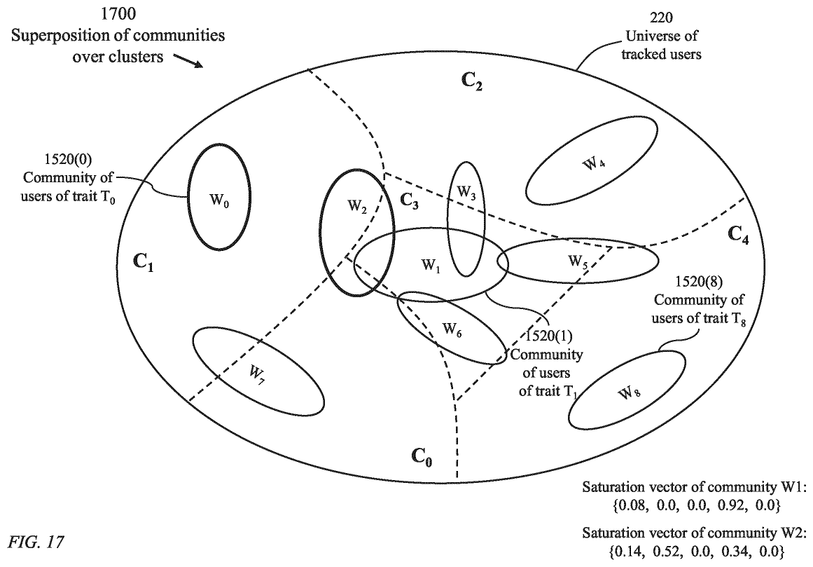

FIG. 17 illustrates superposition 1700 of communities W₀ to W₈ onto clusters C₀ to C₄ indicating saturation of the communities within the clusters. As illustrated, some members of community W₁ belong to cluster C₃ while the remaining members community W₁ belong to cluster C₀. Community W₂ includes members belonging to cluster C₀, members belonging to cluster C₁, and members belonging to cluster C₃. Table-IV below indicates saturation vectors of communities W₀ to W₈ within the set of clusters.

TABLE IV
Saturation vectors of the communities of FIG. 15
within the clusters of FIG. 16

| | | Clusters | | | | |
|---|---|---|---|---|---|---|
| | Community | C₀ | C₁ | C₂ | C₃ | C₄ |
| Saturation | W₀ | 0.0 | 1.0 | 0.0 | 0.0 | 0.0 |
| vectors | W₁ | 0.08 | 0.0 | 0.0 | 0.92 | 0.0 |
| → | W₂ | 0.14 | 0.52 | 0.0 | 0.34 | 0.0 |
| | W₃ | 0.0 | 0.0 | 0.32 | 0.68 | 0.0 |
| | W₄ | 0.0 | 0.0 | 1.0 | 0.0 | 0.0 |
| | W₅ | 0.0 | 0.0 | 0.0.05 | 0.63 | 0.32 |
| | W₆ | 0.12 | 0.0 | 0.0 | 0.84 | 0.04 |
| | W₇ | 0.65 | 0.35 | 0.0 | 0.0 | 0.0 |
| | W₈ | 0.0 | 0.0 | 0.0 | 0.0 | 1.0 |

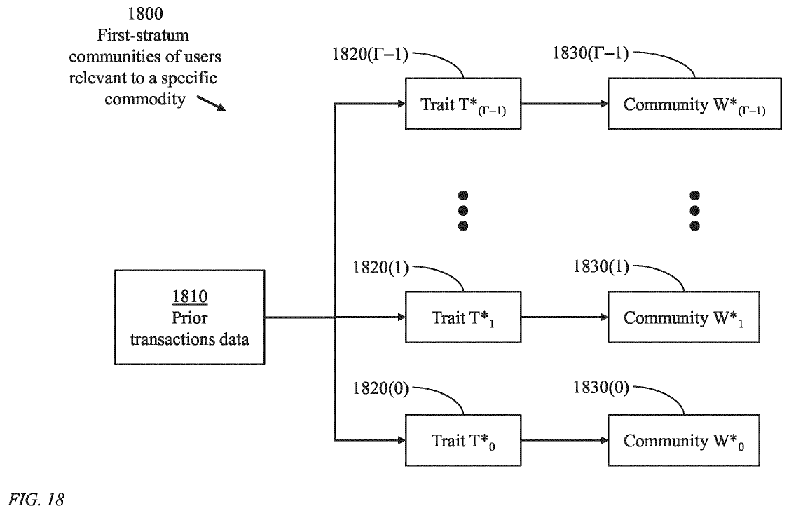

FIG. 18 illustrates determining first-stratum communities 1800 of users corresponding to a specific commodity. Prior transaction data 1810 is analysed to determine a number Γ of significant traits, 1820(0) to 1820(Γ−1), Γ>0, corresponding to the specific commodity. The significant traits are labeled T*₀ to T*_{(Γ-1)}. Corresponding communities 1830(0) to 1830((Γ−1), labeled W*₀ to W*_{(Γ-1)}, are determined from the superset of communities W₀ to W_{H-1} determined in module 430. For example, with Γ=2, W*₀ may correspond to W₂ and W*₁ may correspond to W5.

After determining the primary communities, the primary communities may be indexed as 0 to (Γ−1) and the remaining communities of the superset of communities may be indexed as Γ to (H−1).

Determining Aggregate Kinship and Composite Kinship

Table-V below indicates pairwise kinship levels (also called pairwise kinship coefficients) of a specific candidate community of index k, Γ≤k<H, to each primary community of a set of Γ primary communities for each kinship type.

TABLE V
Pairwise type-specific kinship levels

| | | Relevance of each of primary communities | | | | |
|---|---|---|---|---|---|---|
| Kinship | Kinship | to candidate community | | | | |
| ↓ | weight ↓ | p₀ | p₁ | . . . | p_{(Γ-2)} | p_{(Γ-1)} |
| Type-1 | q₁ | g_{1, 0, k} | g_{1, 1, k} | . . . | g_{1, (Γ-2), k} | g_{1, (Γ-1), k} |
| Type-2 | q₂ | g_{2, 0, k} | g_{2, 1, k} | . . . | g_{2, (Γ-2), k} | g_{2, (Γ-1), k} |
| Type-3 | q₃ | g_{3, 0, k} | g_{3, 1, k} | . . . | g_{3, (Γ-2), k} | g_{3, (Γ-1), k} |

The relevance level, denoted pⱼ, pⱼ≥0.0, of a primary community of index j, 0≤j<Γ, to a commodity under consideration is conjectured or determined from prior-consumers' data as illustrated in FIG. 10. The sum of the Γ relevance levels p₀ to p_{(Γ-1)} is normalized to unity. Thus:

$${p}_{0} + {p}_{1} + … {p}_{( Γ - 2 )} + {p}_{( Γ - 1 )} = 1.0 .$$

Different weights (positive real numbers), denoted q₁, q₂, and q₃ may be assigned to the kinship types. Preferably, the weights are normalized to a sum of unity. Thus, q₁+q₂+q_{3=1.0.}

An aggregate type-t kinship, denoted ξ^{(t)}ₖ, the index t being 1, 2, or 3, of a candidate community of index k, Γ≤k<H, to the set of Γ primary communities, indexed as 0 to (Γ−1), is determined as:

$${ξ}_{k}^{( t )} = {p}_{0} \times {g}_{t , 0 , k} + {p}_{1} \times {g}_{t , 1 , k} + … + {p}_{( Γ - 2 )} \times {g}_{t ( Γ - 2 ) , k} + {p}_{( Γ - 1 )} \times {g}_{t , ( Γ - 1 ) , k} .$$

Determining the aggregate type-specific kinship ξ^{(t)}ₖ is of interest because, for some applications, it may be desired to rely on only one type of kinship.

A composite aggregate kinship, denoted Eₖ, of a candidate community of index k, Γ≤k<H, to the set of Γprimary communities is determined as:

$${E}_{k} = {q}_{1} \times {{ξ}^{( 1 )}}_{k} + {q}_{2} \times {{ξ}^{( 2 )}}_{k} + {q}_{3} \times {{ξ}^{( 2 )}}_{k} . \qquad$$

A composite pairwise kinship, denoted e_{j,k}, of a candidate community of index k, Γ≤k<H, to primary community of index j, 0≤j<Γ, is determined as:

$${e}_{j , k} = {q}_{1} \times {g}_{1 , j , k} + {q}_{2} \times {g}_{2 , j , k} + {q}_{3} \times {g}_{3 , j , k} .$$

Determining the composite pair-wise kinship, e_{j,k}, is of interest because, for some applications, it may be desired to rely on kinship of a candidate community to a single primary community rather than the set of Γ primary communities.

A composite aggregate kinship, denoted E*ₖ, of a candidate community of index k, 0≤k<H, to the set of Γprimary communities is determined as:

$${{E}^{*}}_{k} = {p}_{0} \times {e}_{0 , k} + {p}_{1} \times {e}_{1 , k} + … + {p}_{( Γ - 2 )} \times {e}_{( Γ - 2 ) , , k} + {p}_{( Γ - 1 )} \times {e}_{( Γ - 1 ) , , k} . \\ Notably , {{E}^{*}}_{k} ≡ {E}_{k} .$$

The composite aggregate kinship Eₖ is a robust measure of kinship of a candidate community to a set of primary communities.

Normalized Kinship Levels

The type-1 kinship coefficient g_{1,j,k} (based on overlap of communities) of a candidate community (candidate trait) of index k to a primary community (primary trait) of index j varies between 0.0 and 1.0. Each of type-2 and type-3 kinship coefficients g_{2,j,k} and g_{3,j,k} (based on proximity and cross-correlation, respectively, of saturation vectors) varies between −1.0 and 1.0.

An aggregate kinship level or a composite kinship level is determined as a respective function of pairwise kinship levels. A pairwise kinship of a candidate community to a primary community is taken into account only if the corresponding kinship coefficient at least equals a predetermined positive threshold (of 0.20, for example). Thus, a pairwise kinship level determined to be below the threshold is set to 0.0. In the example of FIG. 11, all pairwise kinship levels considered in computing an aggregate kinship level are above a corresponding threshold.

FIG. 19 illustrates determining a pairwise composite kinship as a weighted sum of corresponding type-1, type-2, and type-3 kinship levels.

Tables 1910, 1920, and 1930 hold pairwise type-1, type-2, and type-3 kinship values of each candidate community to each primary community. Table 1940 indicates a pairwise composite kinship for each pair of a candidate community and a primary community. Each entry in Table 1940 is determined as a weighted sum of corresponding entries in Tables 1910, 1920, and 1930. With H denoting the total number of communities of the superset of communities determined in module 430, and Γ denoting the number primary communities determined in module 450, the H communities of the superset of communities may be indexed so that the primary communities are indexed (reference 1950) as 0 to (Γ−1) and the remaining (H−Γ) communities are indexed (reference 1960) as Γ to (H−1). In the example of FIGS. 19, H=12 and Γ=4. A composite pairwise kinship level determined as:

$${e}_{j , k} = {q}_{1} \times {g}_{1 , j , k} + {q}_{2} \times {g}_{2 , j , k} + {q}_{3} \times {g}_{3 , j , k} ;$$

where 0≤j<Γ, Γ≤k<H. The weighting factors q₁, q₂, and q₃ of the kinship coefficients g_{2,j,k}, and g_{3,j,k}; are prescribed, with q₁+q₂+q₃=1.0.

The type-1 kinship coefficient, g_{1,j,k}, is based on a number of users belonging to the candidate community, a number of users belonging to the specific primary community, and a number of common users belonging to both the candidate community and the specific primary community. The type-2 kinship coefficient, g_{2,j,k}, is based on proximity of the K-dimensional saturation vector of the candidate community to a K-dimensional saturation vector of the specific primary community. The type-3 kinship coefficient, g_{3,j,k}, is based on cross-correlation of the K-dimensional saturation vector of the candidate community to the K-dimensional saturation vector of the specific primary community.

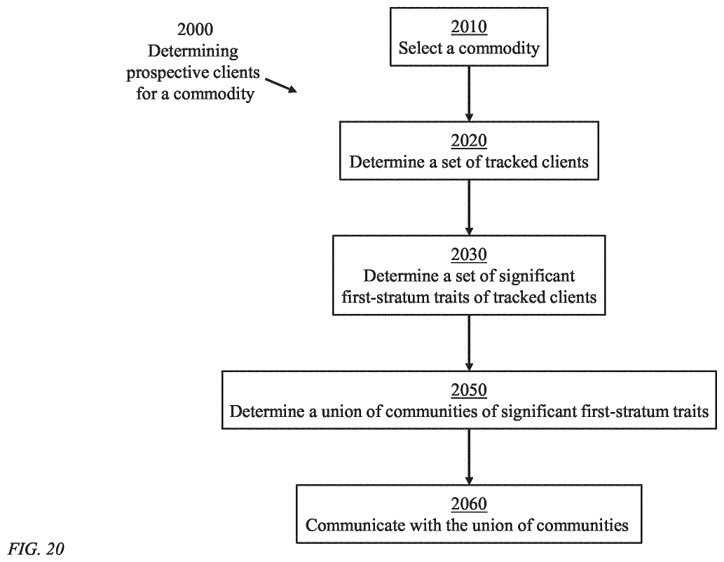

FIG. 20 illustrates a first method 2000 of determining prospective clients for a specific commodity. Step 2010 selects a commodity from a list of commodities of interest. Process 2020 acquires a set of tracked clients of the specific commodity. Process 2030 determines a set of significant first-stratum traits of the tracked clients. Process 2050 determines a union of communities of the significant first-stratum traits. Process 2060 communicates with users of the union of communities of the significant first-stratum traits.

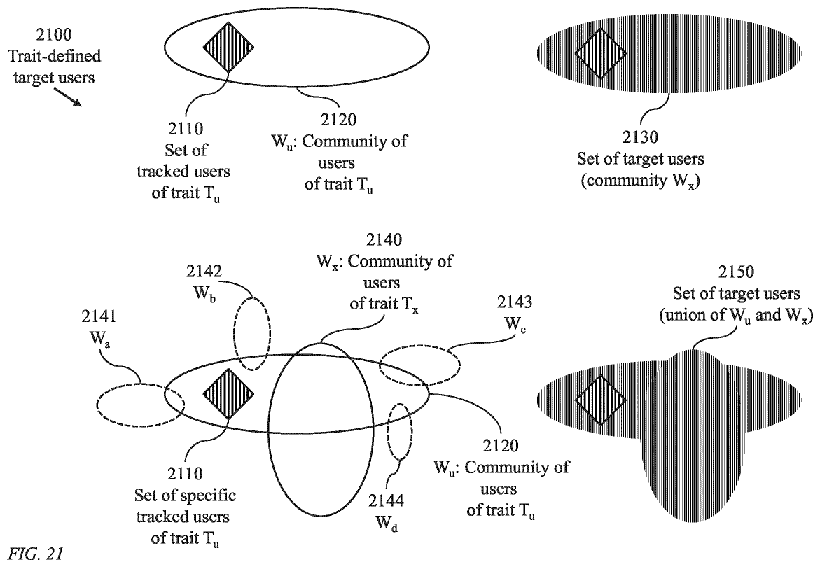

FIG. 21 illustrates trait-defined users 2100 of a significant trait determined from a set of specific tracked users. A set 2110 of tracked users is analyzed to determine a dominant trait from a set of predefined traits of interest. A community 2120 of users of the dominant trait is considered a first-stratum community. The set 2130 of users of community 2120 are considered to be compatible with the commodity under consideration.

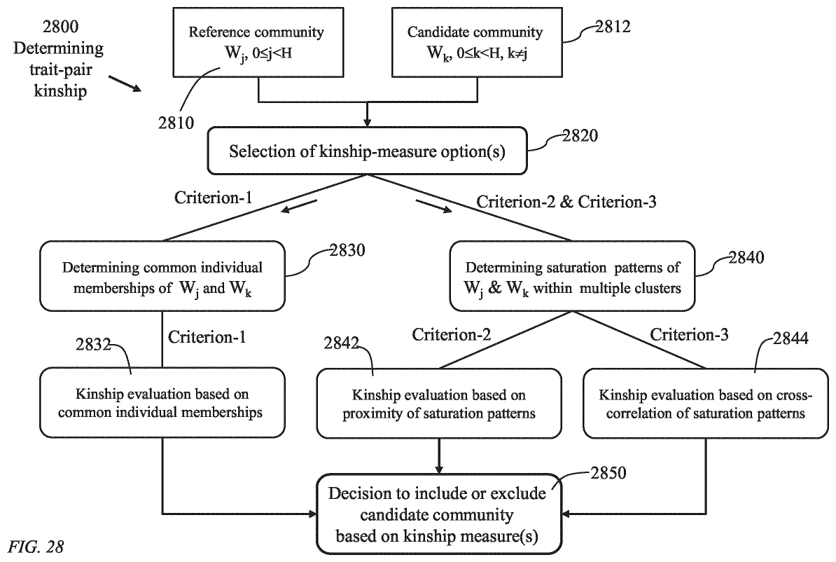

Communities 2140, 2141, 2142, 2143, and 2144 of varying levels of kinship to first-stratum community 2120 are determined using the method of FIG. 28.

Community 2140 of users is determined to have a considerable kinship to community 2120 while communities 2141, 2142, 2143, and 2144 are determined to have insignificant kinship to first-stratum community 2120. Thus, only the users within the union 2150 of communities 2120 and 2140 are considered to be compatible with the commodity under consideration.

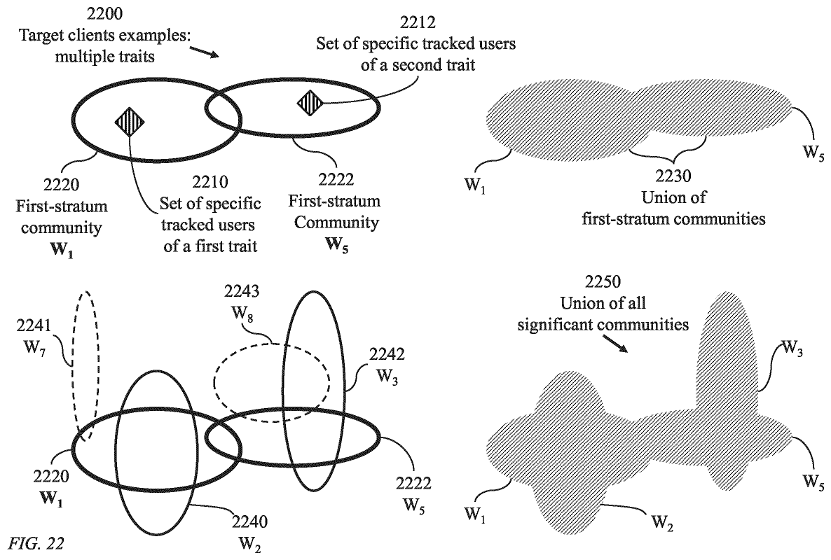

FIG. 22 illustrates associating at least two communities of users with two user traits determined from a set of specific tracked users. Consider the case 2200 of two significant traits of clients of a specific commodity. A set 2210 of tracked users of a first trait and a set 2212 of tracked users of a second trait are determined from known transactions data. A community 2220 of users of the first trait and a community 2222 of users of the second trait are then determined from a database of the superset of communities determined in module 430. The union 2230 of communities 2220 and 2222 constitutes a set of first-stratum users of the first and second traits.

Communities 2240 and 2241 of kinship to first-stratum community 2220 and communities 2242 and 2243 of kinship to first-stratum community 2222 are determined using the method of FIG. 28.

Community 2240 of users is determined to have a considerable kinship to community 2220 while community 2241 is determined to have insignificant kinship to first-stratum community 2220. Community 2242 of users is determined to have a considerable kinship to community 2222 while community 2243 is determined to have slight kinship to first-stratum community 2222. Thus, only the users within the union 2250 of communities 2220, 2222, 2240, and 2242 are considered to be compatible with the commodity under consideration.

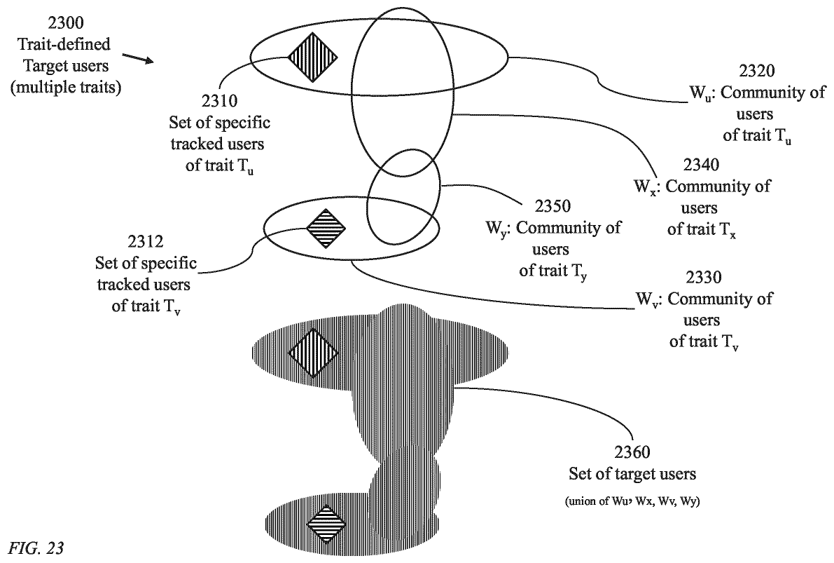

FIG. 23 illustrates an example 2300 of four communities of users associated with two user traits determined from a set of specific tracked users. A set 2310 of tracked users of a first trait and a set 2312 of tracked users of a second trait are determined from known transactions data. A community 2320 of users of the first trait and a community 2330 of users of the second trait are then determined from a database of the superset of communities determined in module 430 (FIG. 4). A community 2340 of users of considerable kinship to community 2320 and a community 2350 of users of considerable kinship to community 2330 are determined (FIG. 28). The users within the union 2360 of communities 2320, 2330, 2340, and 2350 are considered to be compatible with the commodity under consideration.

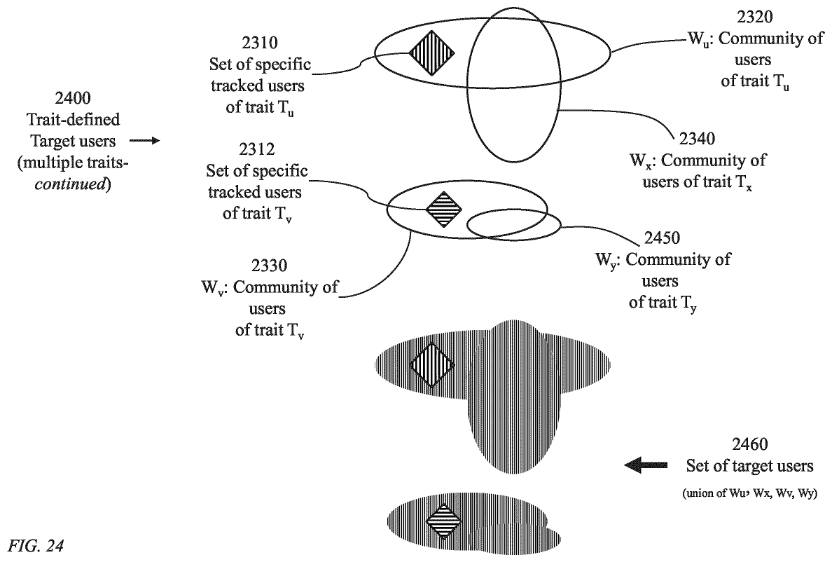

FIG. 24 illustrates another example 2400 of four communities of users associated with two user traits determined from a set of specific tracked users. A community 2450 of users of considerable kinship to community 2330 is determined. The users within the union 2460 of communities 2320, 2330, 2340, and 2450 are considered to be compatible with the commodity under consideration.

FIG. 25 illustrates an alternate indication 2500 of traits' kinship based on saturation levels of communities of users within a set of clusters. Saturation levels of nine communities W₀ to W₈ within five clusters 2510 of users denoted C₀ to C₄, are indicated. Segments 2520 of a community Wⱼ, 0≤j≤H, denoted {Ω_{j,0}, Ω_{j,1}, . . . Ω_{j,K-1}} belonging to clusters C₀ to C_{K-1}, respectively, define a saturation pattern of community Wⱼ within the K clusters of the universe 1620 of tracked users. A saturation-score vector of community Wⱼ within the K clusters is defined as {ν_{j,0}, ν_{j,1}, . . . ν_{j,K-1}}, where ν_{j,k} denotes the number of users within a segment Ω_{j,k}, 0≤j<H, 0≤k<K. A normalized saturation-level vector is determined as {ρ_{j,0}, ρ_{j,1}, . . . , ρ_{j,K-1}} where ρ_{j,k}=(ν_{j,k}/Nⱼ), Nⱼ being the total number of users of community Wⱼ. FIG. 25 illustrates segments 2520 of each of communities W₀, W₁, and W₈ within clusters C₀ to C₄.

FIG. 26 illustrates a method 2600 of determining a second measure of kinship of traits Tᵤ and Tᵥ based on proximity of trait saturation levels within K clusters, K>1. N* denotes the number of users belonging to community Wᵤ of trait Tᵤ, M* denotes the number of users belonging to community Wᵥ of trait Tᵥ, ηⱼ, denotes saturation score of trait Tᵤ within cluster j, and mⱼ denotes saturation score of trait Tᵥ within cluster j, 0≤j<K.

A normalized saturation level αⱼ of trait Tᵤ within cluster j is determined as αⱼ=xⱼ/X*, where xⱼ is a real number equal to integer ηⱼ and X* is a real number equal to N*. Likewise, a normalized saturation level βⱼ of trait Tᵥ within cluster j is determined as βⱼ=yⱼ/Y*, where yⱼ is a real number equal to integer mⱼ and Y* is a real number equal to M*. The absolute value 2610 of a difference of normalized saturation levels of traits Tu and Tv within a cluster j is determined as |αⱼ−βⱼ|. The second measure g_{2,u,v} of kinship of traits Tᵤ and Tᵥ is determined as:

$${g}_{2 , u , v} = 1.0 - {Σ}_{0 \leq j < K} \vert {α}_{j} - {β}_{j} \vert .$$

FIG. 27 illustrates a method 2700 of determining a third measure of kinship of traits Tᵤ and Tᵥ based on cross-correlation of trait saturation patterns 2710 and 2720 within K clusters, K>1.

The third measure g_{3,u,v} of kinship of traits Tᵤ and Tᵥ is determined as:

$${g}_{3 , u , v} = ( {Σ}_{0 \leq j < K} ( {n}_{j} \times {m}_{j} ) - K \times \text{<} \text{n} \text{>} \times \text{<} m \text{>} ) / ( K \times {σ}_{0} \times {σ}_{m} ) ,$$

which may be computed as:

$${g}_{3 , u , v} = ( K \times {Σ}_{0 \leq j < K} ( {n}_{j} \times {m}_{j} ) - {N}^{*} \times {M}^{*} ) / {( ( K \times {Σ}_{0 \leq j < K} {{n}_{j}}^{2} - {N}^{* 2} ) \times ( K \times {Σ}_{0 \leq j < K} {{m}_{j}}^{2} - {M}^{* 2} ) )}^{1 / 2}$$

The notations nⱼ, mⱼ, αⱼ, and βⱼ, 0≤j<K, are defined above with respect to the second measure of kinship. The remaining notations are defined below.

<n>: mean value of saturation scores of trait Tᵤ,
<m>: mean value of saturation scores of trait Tᵥ,
σₙ: standard deviation of the saturation score of trait Tᵤ,
σₘ: standard deviation of the saturation score of trait Tᵥ,
σ_{α}: standard deviation of the normalized saturation level of trait Tᵤ,
σ_{β}: standard deviation of the normalized saturation level of trait Tᵥ,

The measure of kinship, Λ_{u,v} may be selected to be any of the measures g_{1,u,v}, g_{2,u,v}, or g_{3,u,v}. The measure of kinship may also be a function of g_{1,u,v}, g_{2,u,v}, and g_{3,u,v}, such as a weighted sum of the three measures.

FIG. 28 illustrates a method 2800 for determining trait-pair kinship for use in determining second-stratum communities of consumers of a specific commodity. Selecting a community Wⱼ, 0≤j<H, as a reference first-stratum community 2810, each other community Wₖ, 0≤k<H, k≠j, may be considered as a candidate second-stratum community 2812.

A process 2820 selects at least one of three kinship criteria. A first criterion, criterion-1, is based on common memberships of the reference community and a candidate community as described with reference to FIG. 12 and FIG. 13. A second criterion, criterion-2, is based on proximity of trait-saturation patterns of the reference community and a candidate community within the K clusters as described with reference to FIG. 26. A third criterion, criterion-3, is based on cross-correlation of trait-saturation patterns of the reference community and a candidate community within the K clusters as described with reference to FIG. 27.

Process 2830 determines a count of the common membership of the reference community and the candidate community. Process 2832 evaluates a first kinship measure g_{1,r,c} of the reference and candidate communities based on common memberships of the reference community and the candidate community.

Process 2840 determines saturation patterns (saturation vectors) of the reference community and candidate community within the K clusters. Process 2842 evaluates a second kinship measure g_{2,r,c} of the reference and candidate communities based on proximity of the saturation patterns of the reference community and the candidate community. Process 2844 evaluates a third kinship measure g_{3,r,c} of the reference and candidate communities based on cross-correlation of the saturation patterns of the reference community and the candidate community. Process 2850 decides whether to include the candidate community in a set of second-stratum communities of users relevant to the reference community. The decision to include the candidate community may be based on a kinship value determined in any of processes 2832, 2842, or 2844. The decision may also be based on a predefined function of g_{1,r,c}, g_{2,r,c}, and g_{3,r,c}.

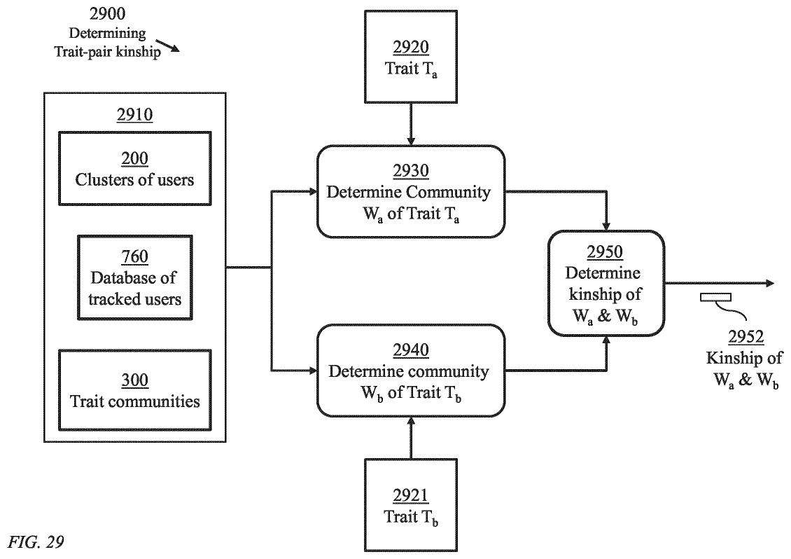

FIG. 29 illustrates a method 2900 of determining a kinship measure of two traits. Process 2930 acquires a (pre-computed) community of users of a first trait 2920, denoted Tₐ, and determines a corresponding community Wₐ. Process 2940 acquires a (pre-computed) community of users of a second trait 2921, denoted T_{b}, and determines a corresponding community W_{b}. Process 2950 determines kinship of the first and second traits using the method of FIG. 28. Processes 2930, 2940, and 2950 rely on input data 2910, comprising user clusters 1600 and trait communities 1500.

FIG. 30 illustrates a second method 3000 of determining prospective clients for the specific commodity. Step 2010, process 2020, and process 2030 perform the same functions described above with reference to FIG. 20. Process 3040 determines a set of significant second-stratum traits relevant to the set of first-stratum traits (FIG. 28). Process 3050 determines a union of communities of the significant traits. Process 3060 communicates with users of the union of communities of the significant traits.

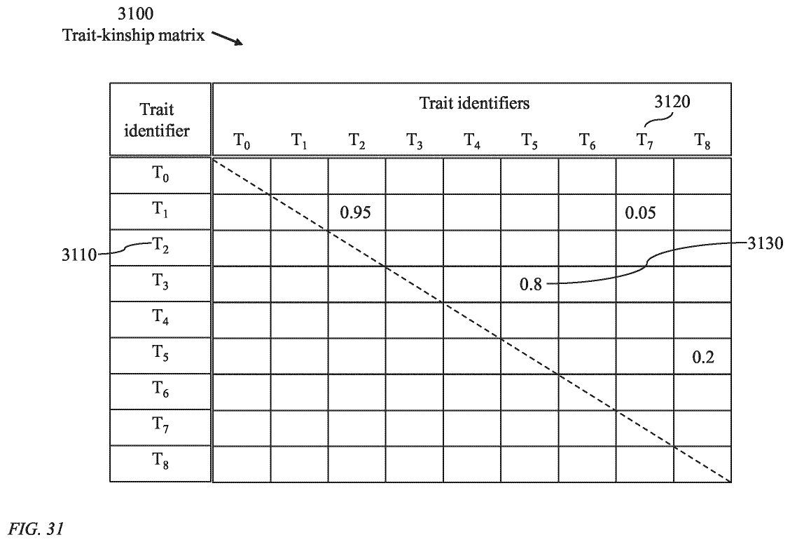

FIG. 31 illustrates a table 3100 of inter-trait kinships for a set of 9 traits (H=9). For each pair of traits {Tⱼ, Tₖ}, 0≤j<H, j<k<H, H=9, a respective kinship value 3130 is determined according to the method of FIG. 28. The kinship value for a trait pair {Tⱼ, Tₖ} equals the kinship value of trait pair {Tₖ, Tⱼ}, thus, it suffices to determine the kinship values for k>j.

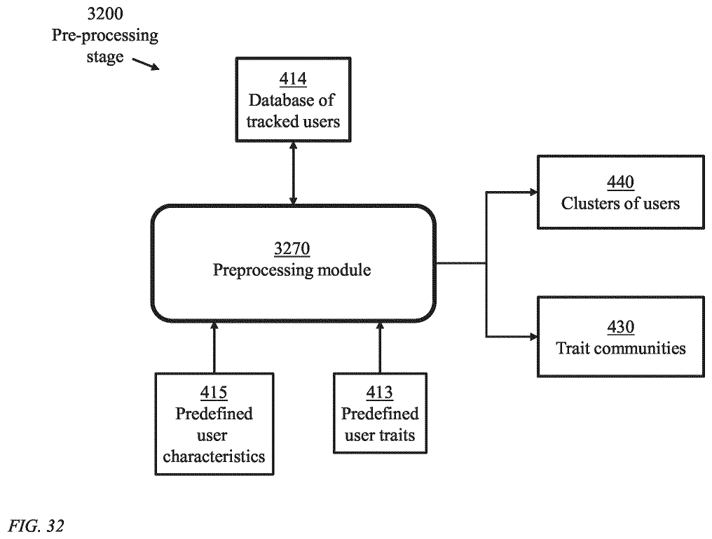

FIG. 32 illustrates a pre-processing stage 3200 for determining clusters of users based on characteristics of users and communities of users corresponding to traits of users. A preprocessing module 3270 acquires values of individual user characteristics (predefined user characteristics 415) of a population of users from database 414 of tracked users. The module also extracts values of individual user traits of interest (predefined superset of traits 413) from database 414.

Module 3270 may comprise module 430 and module 440 (FIG. 4). Module 430 identifies communities 1500 of users corresponding to the predefined user traits 413. Module 440 sorts the population of users into a number of clusters 1600 of users according to the predefined user characteristics. A user may possess multiple distinctive traits while a community is associated with only one trait. Thus, a community may overlap other communities.

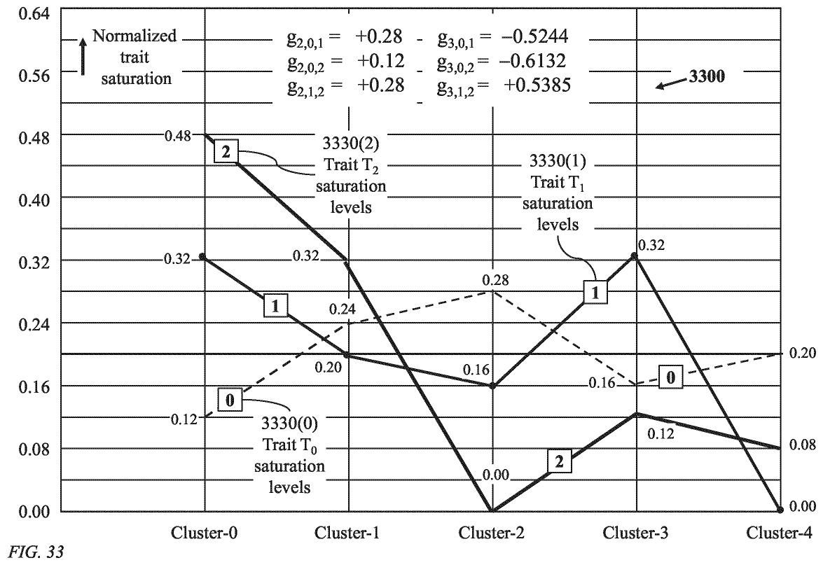

FIG. 33 illustrates trait kinship patterns 3300 of exemplary traits T₀, T₁, and T₂, indicating normalized (0.0 to 1.0) trait-saturation values 3330 of each trait within each of five clusters denoted cluster-0 to cluster-4. Trait-pair kinship values are determined according to the second measure of FIG. 26 and the third measure of FIG. 27. For a trait pair {Tⱼ, Tₖ}, 0≤j≤2, 0≤k≤2, k>j, the kinship value determined according the second measure (trait-patterns proximity) is denoted g_{2,j,k} while the kinship value determined according to the third measure (trait-patterns cross correlation) is denoted g_{3,j,k}.

Table-VI indicates normalized trait-saturation levels for each of traits T₀, T₁, and T₂ within clusters of indices 0 to 4. Table-VI indicates proximity of the saturation levels of each of traits T₀ and T₂ to corresponding saturation levels of trait T₁. Table-V-II indicates kinship values of pairs of traits T₀, T₁, and T₂ based on the second measure and third measure.

As indicated in Table-VII, the sum of absolute values of saturation-level deviation of T₀ from T₁ equals the sum of absolute values of saturation-level deviation of T₂ from T₁. The kinship measure according to the second measure (FIG. 26) is determined as 1.0 minus the sum of absolute values of saturation-level deviation.

TABLE VI
Normalized trait-saturation levels

| Trait | Cluster index | | | | |
|---|---|---|---|---|---|
| identifier | 0 | 1 | 2 | 3 | 4 |
| T₀ | 0.12 | 0.24 | 0.28 | 0.16 | 0.20 |
| T₁ | 0.32 | 0.20 | 0.16 | 0.32 | 0.00 |
| T₂ | 0.48 | 0.32 | 0.00 | 0.12 | 0.08 |

TABLE VII
Deviation from T1 saturation levels

| | | | | | | Sum of |
|---|---|---|---|---|---|---|
| | | | | | | absolute values |
| Trait | Cluster index | | | | | of saturation- |
| identifier ↓ | 0 | 1 | 2 | 3 | 4 | level differences |
| T₀ | −0.20 | 0.04 | 0.12 | −0.16 | 0.20 | 0.72 |
| T₂ | 0.16 | 0.12 | −0.16 | −0.20 | 0.08 | 0.72 |

TABLE VIII
Trait-pair kinship

| | Proximity-based | Cross-correlation-based |
|---|---|---|
| Trait pair | kinship | kinship |
| {T₀, T₁} | 0.28 | −0.5244 |
| {T₀, T₂} | 0.12 | −0.6132 |
| {T₁, T₂} | 0.28 | 0.5385 |

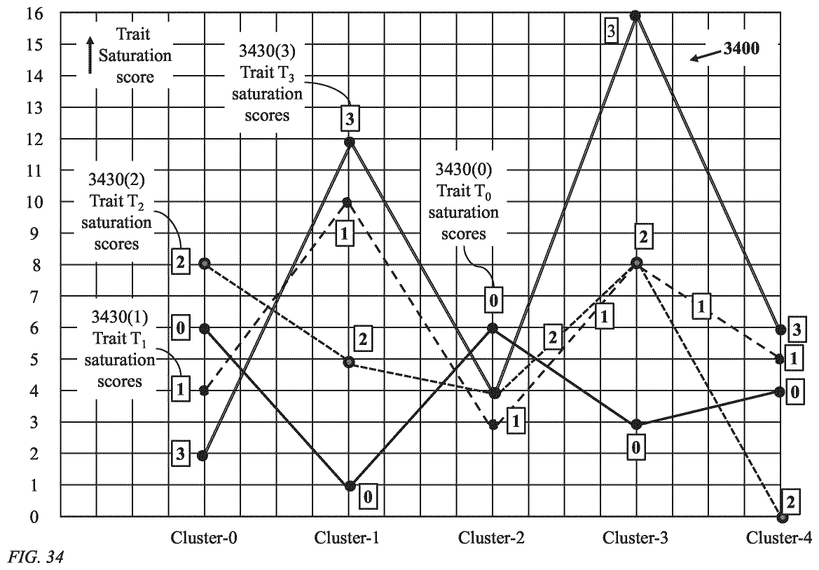

FIG. 34 illustrates exemplary trait-saturation scores 3400 of four traits denoted traits T₀, T₁, T₂, and T₃ within five clusters of indices 0 to 4. The patterns of trait-saturation scores for the individual traits are identified as 3430(0) to 3430(3).

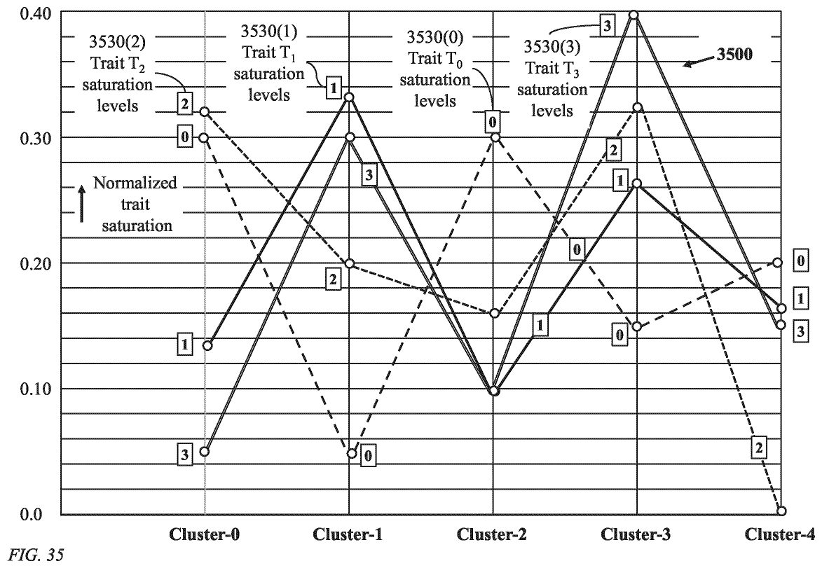

FIG. 35 illustrates normalized trait-saturation levels 3500 corresponding to the trait-saturation scores of FIG. 34. The patterns of normalized trait-saturation levels for the individual traits are identified as 3430(0) to 3430(3).

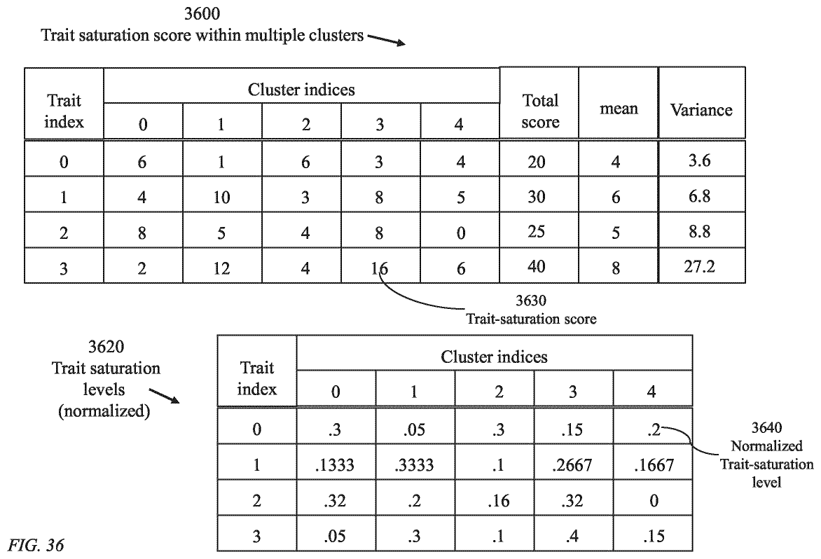

FIG. 36 illustrates a table 3600 of trait-saturation scores 3630 and a table 3620 of normalized trait-saturation levels 3640 corresponding to FIG. 34 and FIG. 35, respectively

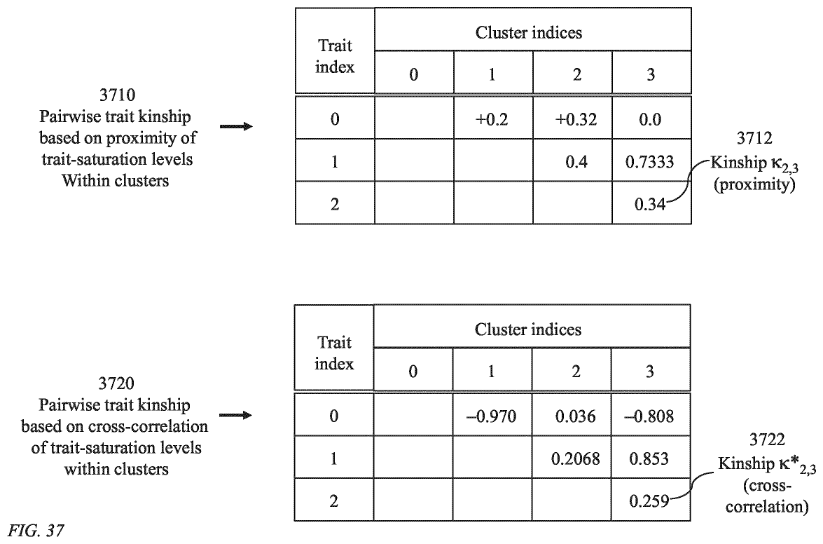

FIG. 37 illustrates a set 2710 of pairwise trait-kinship values 2712 determined according to the second measure of FIG. 26 and a set 3720 of pairwise trait-kinship values 3722 determined according to the third measure of FIG. 27.

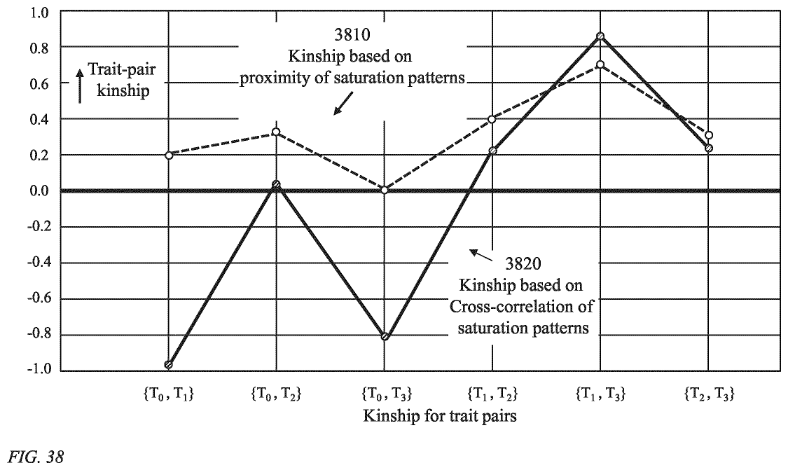

FIG. 38 compares kinship levels 3810 based on proximity of trait-saturation patterns and kinship levels 2820 based on cross correlation of trait-saturation patterns as indicated in FIG. 37.

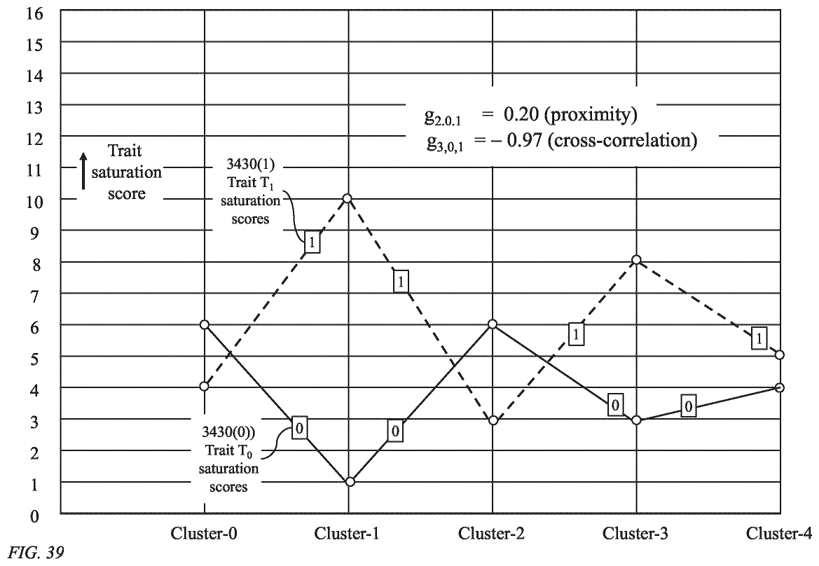

FIG. 39 illustrates pattern 3430(0) of the trait-saturation scores of a trait T₀ and pattern 3430(1) of trait-saturation scores of a trait T₁ of FIG. 34. As indicated in FIG. 37, the proximity-based kinship measure g_{2,0,1} is determined as 0.2 while the kinship measure g_{3,0,1} based on cross-correlation of patterns 3430(0) and 3430(1) is determined as −0.97. The kinship measure g_{3,0,1} reveals the strong negative correlation of the two patterns.

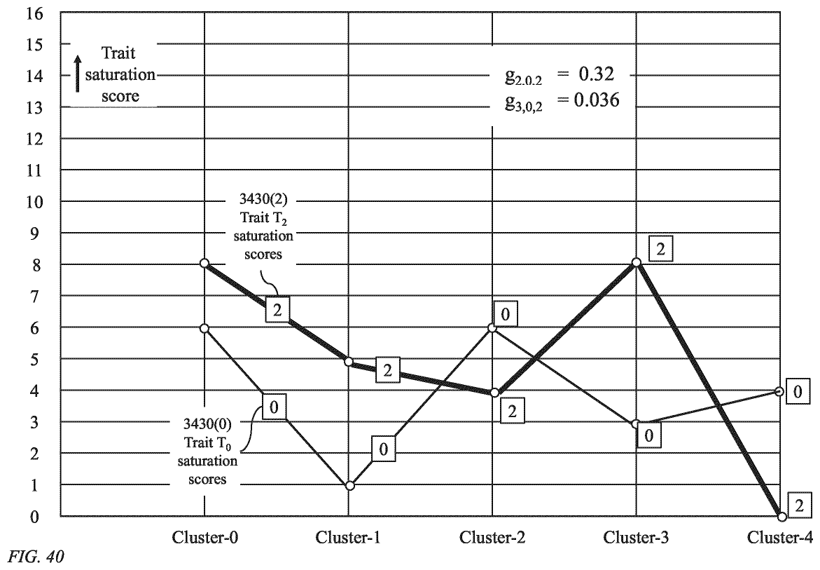

FIG. 40 illustrates pattern 3430(0) of the trait-saturation scores of a trait T₀ and pattern 3430(2) of trait-saturation scores of a trait T₂ of FIG. 34. As indicated in FIG. 37, the proximity-based kinship measure g_{2,0,2} is determined as 0.32 while the kinship measure g_{3,0,2} based on cross-correlation of patterns 3430(0) and 3430(2) is determined as 0.036. The insignificant kinship measure g_{3,0,2} of 0.036 is indicative of a weak correlation of the two patterns.

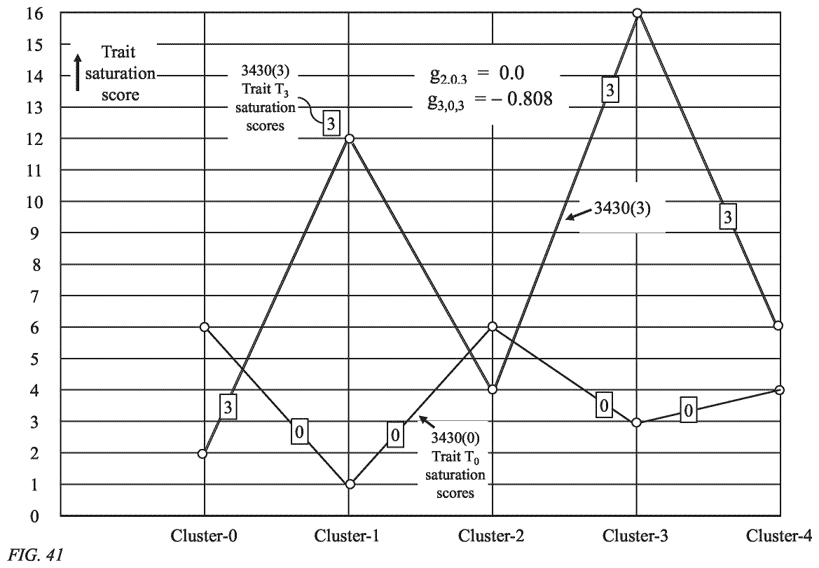

FIG. 41 illustrates pattern 3430(0) of the trait-saturation scores of a trait T₀ and pattern 3430(3) of trait-saturation scores of a trait T₃ of FIG. 34. As indicated in FIG. 37, the proximity-based kinship measure g_{2,0,3} is determined as 0.0 while the kinship measure g_{2,0,3} based on cross-correlation of patterns 3430(0) and 3430(3) is determined as −0.808. The kinship value g_{2,0,3} of −0.808 is indicative of a strong negative correlation of the two patterns.

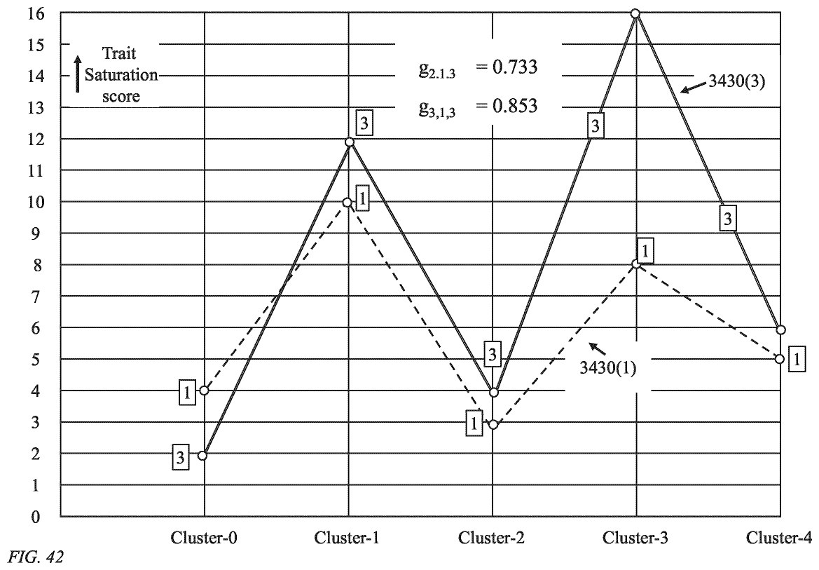

FIG. 42 illustrates pattern 3430(1) of the trait-saturation scores of a trait T₁ and pattern 3430(3) of trait-saturation scores of a trait T₃ of FIG. 24. As indicated in FIG. 37, the proximity-based kinship value g_{2,1,3} is determined as 0.733 while the kinship value g_{3,1,3} based on cross-correlation of patterns 3430(1) and 3430(3) is determined as 0.853. The kinship value g_{2,1,3} of 0.733 is indicative of close proximity of the two patterns. The kinship value g_{3,1,3} of 0.853 is indicative of a strong positive correlation of the two patterns.

As illustrated in FIG. 26 and FIG. 27, the second and third kinship measures of two communities are based on saturation scores (or saturation levels) of communities within a number K of clusters, K>1. The saturation score of a community within a cluster is determined as a count of the number of users of the community within the cluster.

Alternatively, the users of a cluster may be given different weights according to proximity to a centroid of the cluster. The saturation score of a community within a cluster may then be determined as a sum of weights of common users of the community and the cluster.

As described above, the process of selecting a candidate community as a second-stratum community may be based on:

a first kinship measure determined according to common membership with the first-stratum communities;

a second kinship measure based on proximity of a saturation-level vector of a candidate community to saturation-level vectors of first-stratum communities; and/or

a third kinship measure based on cross-correlation of the saturation-level vector of the candidate community to saturation-level vectors of the first-stratum communities.

The candidate community qualifies as a second-stratum community based on one of the three kinship measures or based on a function of the three kinship measures. A set of prospective clients is determined as a union of the first stratum communities and resulting second-stratum communities.

Alternatively:

a first set of second-stratum communities may be determined based on the first kinship measure only;

a second set of second-stratum communities may be determined based on the second kinship measure only;

a third set of second-stratum communities may be determined based on the third kinship measure only; and

a set of prospective clients may be determined as a union of the first-stratum communities and the three sets of second-stratum communities.

The three sets of second-stratum communities may include common users, or may even be identical.

The three sets of secondary communities may intersect, i.e., include common users, or may even be identical. Users belonging to two or more primary or secondary communities may be considered distinct prospective clients.

The methods of the present invention have numerous advantages over the prior art. At least some of the advantages include:
(1) comprehensive thorough analysis of massive data to appropriately determine prospective clients for a product or a service;
(2) novel approaches that consider factors that enable intelligent marketing, such as traits of potential consumers for specific commodities and pairwise trait kinship;
(3) multi-stratum classification of prospective clients which is of paramount importance to strategic marketing;
(4) computationally efficient algorithms for handling massive data, which operate faster than the prior art algorithms;
(5) ease of expansion to add new features as exemplified in FIGS. 4 to 9; and
(6) ease of implementation in a flexible modular hardware structure.

Methods of the embodiments of the invention may be performed using at least one hardware processor, executing processor-executable instructions causing the at least one hardware processor to implement the processes described above. Computer executable instructions may be stored in processor-readable storage media such as floppy disks, hard disks, optical disks, Flash ROMs (read only memories), non-volatile ROM, and RAM (random access memory). A variety of processors, such as microprocessors, digital signal processors, and gate arrays, may be employed.

Systems of the embodiments of the invention may be implemented as any of a variety of suitable circuitry, such as one or more microprocessors, digital signal processors (DSPs), application-specific integrated circuits (ASICs), field programmable gate arrays (FPGAs), discrete logic, software, hardware, firmware or any combinations thereof. When modules of the systems of the embodiments of the invention are implemented partially or entirely in software, the modules contain a memory device for storing software instructions in a suitable, non-transitory computer-readable storage medium, and software instructions are executed in hardware using one or more processors to perform the methods of this disclosure.

It should be noted that methods and systems of the embodiments of the invention and data described above are not, in any sense, abstract or intangible. Instead, the data is necessarily presented in a digital form and stored in a physical data-storage computer-readable medium, such as an electronic memory, mass-storage device, or other physical, tangible, data-storage device and medium. It should also be noted that the currently described data-processing and data-storage methods cannot be carried out manually by a human analyst due the complexity and vast numbers of intermediate results generated for processing and analysis of even quite modest amounts of data. Instead, the methods described herein are necessarily carried out by electronic computing systems having processors on electronically or magnetically stored data, with the results of the data processing and data analysis digitally stored in one or more tangible, physical, data-storage devices and media.

Although specific embodiments of the invention have been described in detail, it should be understood that the described embodiments are intended to be illustrative and not restrictive. Various changes and modifications of the embodiments shown in the drawings and described in the specification may be made within the scope of the following claims without departing from the scope of the invention in its broader aspect.

1. A method of determining prospective clients for a specific commodity, the method comprising:
executing instructions causing a processor to perform processes of:
selecting a specific commodity from a list of commodities of interest;
acquiring data relevant to prior clients of the specific commodity;
determining a set of relevant traits of the prior clients based on said data, the set of relevant traits belonging to a predefined superset of traits;
determining a superset of communities of a universe of users, each community corresponding to a respective trait of the predefined superset of traits;
selecting a set of primary communities, corresponding to the set of relevant traits, from the superset of communities; and
determining a set of prospective clients comprising users belonging to the primary communities.

2. The method of claim 1 further comprising:
acquiring sizes of communities corresponding to the predefined superset of traits;
initializing a set of relevant traits as an empty set;
determining for each trait of the predefined traits a trait score as a number of clients of the set of prior clients determined to have said each trait;
prorating each trait score to a nominal community size to produce prorated initial scores;
transferring a particular trait of highest prorated score to the set of relevant traits;
adjusting the score of each of the remaining traits to exclude users already included in the particular trait; and
repeating said prorating, transferring, and adjusting until the highest score of the remaining traits of the set of predefined traits is below a predefined level.

3. The method of claim 1 further comprising:
determining candidate secondary communities from the superset of communities based on a measure of kinship of each community, excluding the primary communities, to the set of primary community;
selecting a set of secondary communities; and
determining an expanded set of prospective clients to account for both the primary communities and the secondary communities.

4. The method of claim 3 further comprising determining a first measure of pairwise kinship of a first community to a second community as:
a ratio of a number of common users belonging to the intersection of the two communities to a number of users belonging to the union of the two communities;
or
a ratio of a number of common users belonging to the intersection of the two communities to an arithmetic mean value of the number of users belonging to the first community and the number of users belonging to the second community;
or
a ratio of a number of common users belonging to the intersection of the two communities to a geometric mean value of the number of users belonging to the first community and the number of users belonging to the second community.

5. The method of claim 3 further comprising
segmenting the universe of users into a set of clusters according to individual characteristics of each user of the universe of users;
determining a saturation-score vector of each community of the superset of communities as a size of intersection of said each community with each cluster of the set of clusters; and
normalizing said saturation-score vector to a sum of unity to produce a saturation-level vector.

6. The method of claim 5 further comprising determining a second measure of pairwise kinship of a first community to a second community based on proximity of saturation-level vectors of the two communities.

7. The method of claim 5 further comprising determining a third measure of pairwise kinship of a first community to a second community based on cross-correlation of saturation-level vectors of the two communities.

8. The method of claim 7 wherein the kinship measure of any secondary community to any primary community is determined as a function of at least two of:
a ratio the intersection of the two communities to the union of the two communities;
a proximity coefficient of saturation vectors of the two communities; and
a cross-correlation coefficient of saturation vectors of the two communities.

9. The method of claim 5 wherein said determining a set of communities of the universe of users and segmenting the universe of users into a set of clusters are performed a priori in pre-processing modules.

10. The method of claim 1 wherein said set of prospective clients is determined as a union of the primary communities, the method further comprising identifying users belonging to intersections of the primary communities as distinct prospective clients.

11. The method of claim 3 wherein said expanded set of prospective clients is determined as a union of the primary communities and the secondary communities, the method further comprising identifying users belonging to intersections of communities belonging to the set of primary communities and the set of secondary communities as distinct prospective clients.

12. The method of claim 3 further comprising communicating information relevant to the specific commodity to: the set of prospective clients; or the expanded set of prospective clients.

13. The method of claim 3 wherein the measure of kinship is a weighted sum of pairwise kinship values of said each candidate secondary community to the set of primary community determined as:
$${Λ}_{k}^{*} = {Σ}_{0 \leq j < Γ} ( {p}_{j} \times {Λ}_{j . k} ) ;$$
pⱼ denoting a relevance level of a primary community of index j to the specific commodity, and
Λ_{j,k} denoting pairwise kinship of a candidate community of index k to a primary community of index j, 0≤j<Γ, Γ≤k<H, H being a count of the total number of communities of the set of communities, Γ being a count of the primary communities, indexed as 0 to (Γ−1).

14. The method of claim 5 further comprising determining a first measure of pairwise kinship of a first community of index u to a second community of index v as:
$${g}_{1 , u , v} = {N}_{c} / ( {N}_{u} + {N}_{v} - {N}_{c} ) ;$$
$$or$$
$${g}_{1 , u , v} = 2 \times {N}_{c} / ( {N}_{u} + {N}_{v} ) ;$$
$$or$$
$${g}_{1 , u , v} = {N}_{c} / {( {N}_{u} + {N}_{v} )}^{1 / 2} ;$$
wherein Nu is a number of users belonging to the first community, Nv is the number of users belonging to the second community, and Nc is the number of users belonging to the intersection of the first community and the second community.

15. The method of claim 5 further comprising determining a second measure of pairwise kinship of a first community of index u to a second community of index v as:
$${g}_{2 , u , v} = 1.0 - {Σ}_{0 \leq j < K} \vert {α}_{j} - {β}_{j} \vert ,$$
where:
K is the number of clusters, K>1;
αⱼ is a normalized saturation level of the first community within cluster j determined as a ratio of the number of users belonging to both the first community and cluster j to the number of users belonging to the first community; and
βⱼ is a normalized saturation level of the second community within cluster j determined as a ratio of the number of users belonging to both the second community and cluster j to the number of users belonging to the second community.

16. The method of claim 5 further comprising determining a third measure of pairwise kinship of a first community of index u to a second community of index v as:
$${g}_{3 , u , v} = ( {Σ}_{0 \leq j < K} ( {n}_{j} \times {m}_{j} ) - K \times \text{<} \text{n} \text{>} \times \text{<} m \text{>} ) / ( K \times {σ}_{n} \times {σ}_{m} ) ,$$
where:
K is the number of clusters, K>1;
nⱼ, is a saturation score of the first community within cluster j,
mⱼ is saturation score of the second community within cluster j, 0≤j<K,
<n> is the mean value of saturation scores of the first community,
<m> is the mean value of saturation scores of the second community,
σₙ is the standard deviation of the saturation score of the first community, and
σₘ is the standard deviation of the saturation score of the second community.

17. A method of advertising a specific commodity implemented at an apparatus comprising a processor and memory devices, the method comprising:
accessing a database indicating traits, of a predefined superset of traits, of each user of a population of users;
determining a superset of communities, each community comprising users, of the population of users, possessing a respective trait of the predefined superset of traits;
receiving identifiers of a set of primary communities of interest belonging to the superset of communities;
initializing a set of secondary communities as an empty set;
for said each community, excluding said set of primary communities:
determining a measure of kinship to the set of primary communities; and
adding said each community to the set of secondary communities subject to a determination that the measure of kinship exceeds a predefined level;
and
determining a set of prospective clients based on the set of primary communities and the set of secondary communities.

18. The method of claim 17 wherein said measure of kinship is determined as a weighted sum of pairwise kinship levels of said each community, excluding said set of primary communities, to each primary community of the set of primary communities.

19. The method of claim 18 further comprising:
segmenting the plurality of users into a number K of clusters, K>1, according to individual characteristics of users of the plurality of users; and
determining a K-dimensional saturation vector of said each community within the K clusters, the K-dimensional saturation vector being defined according to intersection of said each community with each cluster of said K clusters.

20. The method of claim 18 wherein a pairwise kinship level of said each community to a specific primary community of the set of primary communities is determined according to:
a number of users belonging to said each community, a number of users belonging to said specific primary community, and a number of common users belonging to both said each community and said specific primary community;
or
proximity of a K-dimensional saturation vector of said each community to a K-dimensional saturation vector of said specific primary community;
or
cross-correlation of said K-dimensional saturation vector of said each community to said K-dimensional saturation vector of said specific primary community.

21. The method of claim 18 further comprising determining a composite pairwise kinship level of said each community to a specific primary community of the set of primary communities as:
$$e j , k = {q}_{1} \times {g}_{1 , j , k} + {q}_{2} \times {g}_{2 , j , k} + {q}_{3} \times {g}_{3 , j , k} ;$$
$${q}_{1} + {q}_{2} + {q}_{3} = 1.0 ;$$
0≤j<Γ, Γ≤k<H, H being a count of the total number of communities of the set of communities, Γ being a count of the primary communities, indexed as 0 to (Γ−1);
g_{1,j,k} is a type-1 kinship coefficient based on a number of users belonging to said each community, a number of users belonging to said specific primary community, and a number of common users belonging to both said each community and said specific primary community;
g_{2,j,k} is a type-2 kinship coefficient based on proximity of a K-dimensional saturation vector of said each community to a K-dimensional saturation vector of said specific primary community; and
g_{3,j,k; k} is a type-3 kinship coefficient based on cross-correlation of said K-dimensional saturation vector of said each community to said K-dimensional saturation vector of said specific primary community.

22. The method of claim 21 further comprising determining said measure of kinship as a composite aggregate kinship of a candidate community of index k, 0≤k<H, to the set of Γ primary communities as:
$${E}_{k} = {p}_{0} \times {e}_{0 , k} + {p}_{1} \times {e}_{1 , k} + … + {p}_{( Γ - 2 )} \times {e}_{( Γ - 2 ) , k} + {p}_{( Γ - 1 )} \times {e}_{( Γ - 1 ) , , k} .$$
pj, 0≤j<Γ, being a relevance level of a primary community of index j to the specific commodity.

23. A marketing inference engine, comprising:
a memory device having computer executable instructions stored thereon for execution by a processor, forming:
a first module for determining a superset of communities of users, of a tracked population of users, wherein each community comprises users of a respective trait of a predetermined superset of predefined traits;
a second module for determining relevant traits for a specific commodity based on records of prior client transactions;
a third module for determining primary communities of the superset of communities corresponding to the relevant traits; and
a fourth module for determining prospective clients based on at least the primary communities.

24. The marketing inference engine of claim 23, further comprising:
a fifth module for determining type-1 pairwise kinships of candidate communities of the superset of communities to the primary communities based on overlap of each candidate community with the primary communities; and
a sixth module for:
selecting secondary communities based on values of the type-1 pairwise kinship of candidate communities; and
supplying data relevant to the secondary communities to the fourth module for expanding the set of prospective clients to account for both the primary communities and the secondary communities.

25. The marketing inference engine of claim 23, further comprising:
a seventh module for segmenting the population of users into a set of clusters according to individual characteristics of each user of the universe of users; and
an eighth module for:
determining a saturation-score vector of each community of the superset of communities as a size of intersection of said each community with each cluster of the set of clusters; and
determining type-2 pairwise kinships of communities based on trait saturation within individual clusters of the set of clusters; and
determining type-2 pairwise kinship values of candidate communities of the superset of communities, other than the primary communities, to the primary communities based on proximity of a saturation-level vector of each candidate community to a respective saturation-level vector of each primary community.

26. The marketing inference engine of claim 23, wherein said eighth module is further configured to determine type-3 pairwise kinship values of candidate communities of the superset of communities, other than the primary communities, to the primary communities based on cross-correlation of a saturation-level vector of each candidate community and a respective saturation-level vector of each primary community.

27. The marketing inference engine of claim 26, further comprising a ninth module for:
determining secondary communities according to the type-2 pairwise kinships of communities or the type-3 pairwise kinships of communities; and
communicating data relevant to the secondary communities to the fourth module for expanding the set of prospective clients to account for both the primary communities and the secondary communities.

28. A marketing system, comprising:
a processor; and
a marketing inference engine, comprising a memory device having computer executable instructions stored thereon for execution by the processor, forming:
a first module for determining a superset of communities of users, of a tracked population of users, wherein each community comprises users of a respective trait of a predetermined superset of predefined traits;
a second module for determining relevant traits for a specific commodity based on records of prior client transactions;
a third module for determining primary communities of the superset of communities corresponding to the relevant traits; and
a fourth module for determining prospective clients based on at least the primary communities.

29. A system for determining prospective clients for a specific commodity, comprising:
a processor;
a computer memory storing processor executable instructions thereon, for execution by the processor, causing the processor to:
select a specific commodity from a list of commodities of interest;
acquire data relevant to prior clients of the specific commodity;
determine a set of relevant traits of the prior clients based on said data, the set of relevant traits belonging to a predefined superset of traits;
determine a superset of communities of a universe of users, each community corresponding to a respective trait of the predefined superset of traits;
select a set of primary communities, corresponding to the set of relevant traits, from the superset of communities; and
determine a set of prospective clients comprising users belonging to the primary communities.

30. A system for advertising a specific commodity, comprising:
a processor;
a computer memory storing processor executable instructions thereon, for execution by the processor, causing the processor to:
access a database indicating traits, of a predefined superset of traits, of each user of a population of users;
determine a superset of communities, each community comprising users, of the population of users, possessing a respective trait of the predefined superset of traits;
receive identifiers of a set of primary communities of interest belonging to the superset of communities;
initialize a set of secondary communities as an empty set;
for said each community, excluding said set of primary communities:
determine a measure of kinship to the set of primary communities; and
add said each community to the set of secondary communities subject to a determination that the measure of kinship exceeds a predefined level;
and
determine a set of prospective clients based on the set of primary communities and the set of secondary communities.
